(19) United States
(12) Patent Application Publication
(10) Pub. No.: US 2004/0002420 A1
(43) Pub. Date: Jan. 1, 2004

(54) Stable catalysts and co-catalyst compositions formed from hydroxyaluminoxane and their use

(76) Inventors: Feng-Jung Wu, Baton Rouge, LA (US); Christopher G. Bauch, Prairieville, LA (US); Larry S. Simeral, Baton Rouge, LA (US); Jamie R. Strickler, Baton Rouge, LA (US)

Correspondence Address: Mr. Philip M. Pippenger, Law Department, Albemarle Corporation, 451 Florida Street, Baton Rouge, LA, 70801-1765, US

(21) Appl. No.: 10/379,847

(22) Filed: Mar. 5, 2003

Related U.S. Application Data
(63) Continuation-in-part of application No. 09/946,881, filed on Sep. 5, 2001.
Application No. 09/946,881 is a continuation-in-part of application No. 09/655,218, filed on Sep. 5, 2000, now Pat. No. 6,462,212.
Application No. 09/655,218 is a continuation-in-part of application No. 09/177,736, filed on Oct. 23, 1998, now Pat. No. 6,160,145.

(51) Int. Cl. B01J 31/00; C07F 5/06

(52) U.S. Cl. 502/171; 534/15; 556/182

(57) ABSTRACT

Surprisingly stable olefin polymerization catalysts and co-catalysts formed from hydroxyaluminoxanes are revealed. In one embodiment of the invention, a solid composition of matter is formed from a hydroxyaluminoxane and a treating agent, whereby the rate of OH-decay for the solid composition is reduced as compared to that of the hydroxyaluminoxane. Gelatinous compositions of matter formed from hydroxyaluminoxane and having similar stability characteristics are also disclosed. Processes for converting a hydroxyaluminoxane into a such compositions of matter, supported catalysts formed from such co-catalyst compositions of matter, as well as methods of their use, are described.

### REFERENCE TO RELATED APPLICATIONS

The present application is based on and claims priority of International Application No. PCT/US01/27449, filed Sep. 5, 2002, published in English on Mar. 14, 2002, which in turn is based in part on and claims priority of U.S. application. Ser. No. 09/655,218, now U.S. Pat. No. 6,462,212. U.S. application Ser. No. 09/655,218 in turn is a continuation in part of U.S. application. Ser. No. 09/177,736, now U.S. Pat. No. 6,160,145. The present application is also a continuation in part of copending U.S. application Ser. No. 09/946,881, filed Sep. 5, 2001, which is a continuation in part of Ser. No. 09/655,218, which in turn is a continuation in part of Ser. No. 09/177,736.

### TECHNICAL FIELD

This invention relates to novel stable olefin polymerization catalyst compositions, to compositions of matter which are highly effective as catalyst components, and to the preparation and use of such compositions.

### BACKGROUND

U.S. Pat. No. 6,160,145 to Wu et al. describes transition metal compounds having conjugate aluminoxate anions and their use as catalyst components, and methods for their preparation and use as olefin polymerization catalysts. The differences between those compounds and prior art aluminoxanes (a.k.a. alumoxanes), as well as references to various prior art references on metal catalysts, are also described in the background provided in U.S. Pat. No. 6,160,145.

This invention involves the discover, inter alia, that the catalyst compositions described in U.S. Pat. No. 6,160,145 and also herein can have exceptional stability once recovered and maintained under suitable conditions in the absence of a solvent.

It has also been discovered that the meta-stable nature of the hydroxy groups in the hydroxyaluminoxane species of aluminoxanes can have an negative impact upon the shelf life of this species of compounds. Increasing the steric bulk of these compounds does appear to increase the lifetime of their OH groups (see, e.g., FIG. 6), but not sufficiently to meet the anticipated needs of commercial applications. Storage of these compounds at low temperature, e.g., circa −10° C., can significantly increase the compound lifetime (see, e.g., FIG. 7), but cost and operational considerations of this technique also are less that ideal for commercial applications. Accordingly, a need exists for a way to significantly increasing the lifetime of the OH groups in hydroxyaluminoxanes, preferably at or near room temperature. A need also exists for a facile way to employ olefin polymerization catalysts while avoiding reactor fouling.

### BRIEF SUMMARY OF THE INVENTION

There are three general aspects of the present invention.

First Aspect

The first aspect of this invention is the discovery that, surprisingly, the catalyst compositions as described in U.S. Pat. No. 6,160,145 and also herein can have exceptional stability once recovered and maintained under suitable conditions in the absence of a solvent. In fact, it has been found possible to store a solid catalyst of this type in a drybox at ambient room temperatures for a one-month period without loss of its catalytic activity. In contrast, the same catalyst composition is relatively unstable if left in the reaction solution or put in solution after it has been removed from solution.

The first aspect of this invention thus makes it possible, apparently for the first time ever, to prepare an active olefin polymerization catalyst that is sufficiently stable in unsupported form to be placed in storage and shipped for use long after it has been prepared. So far as is known, it has not been possible heretofore to do this with unsupported catalysts. Only with certain active olefin polymerization catalysts on catalyst supports has this been accomplished previously.

Because these active catalysts are more stable in their undissolved state than when they are in solution, it is now possible to prepare both unsupported and supported olefin polymerization catalyst compositions that can be stored and shipped in undissolved form. The catalyst compositions of this first aspect of the invention are typically kept in an atmosphere of dry inert gas or in a vacuum after the catalyst has been formed and recovered, and optionally, subjected to one or more finishing procedures. By “finishing procedure” is meant any procedure or operation which neither significantly changes the chemical composition of the catalyst nor excessively diminishes the catalytic activity of the catalyst to such an extent that it is no longer of practical utility as a catalyst, which procedure or operation involves having the catalyst in solution or slurry form in order to conduct the procedure or operation and that is conducted at any time after such catalyst has been formed and recovered from the medium in which it was formed, excluding of course, the use of the catalyst in a polymerization reaction. Finishing procedures thus can include such procedures or operations as purifying the catalyst, improving the appearance of the catalyst, converting the catalyst into a supported catalyst, and the like. For example, after its formation and recovery (isolation) from the medium in which it was formed, the catalyst can be purified and/or cosmetically improved by dissolving the catalyst in, and crystallizing or precipitating the catalyst from, a suitable solvent followed by drying, or washing the catalyst with a suitable anhydrous inert solvent followed by drying, all under an inert anhydrous atmosphere, and/or by use of some other purification procedure(s) and/or appearance-improving procedure(s) that involve having the catalyst in solution or slurry form during all or a portion of the procedure(s), and that do not significantly change the chemical composition or excessively diminish the catalytic activity of the catalyst so that it is no longer useful as a catalyst for polymerization of, say, ethylene or propylene. Another example of a finishing procedure is the preparation of a supported catalyst, such as by depositing the catalyst on a catalyst support material from a solution of the catalyst. It will of course be understood that during a finishing procedure the catalyst should be not be exposed to water or any other substance or condition that will materially destroy its catalytic activity or materially change its chemical composition.

Some finishing procedure(s) would be conducted before storing the purified compound in a dry inert environment such as in an anhydrous inert atmosphere or under vacuum. However the optional finishing procedure can be performed whenever it is appropriate to do so. Thus it is within the scope of this invention to carry out any finishing procedure at any time after the catalyst has been formed and recovered from the medium in which it was formed. As noted above, use of the catalyst as a catalyst or catalytic component does not come within the meaning of a finishing procedure.

After preparation and recovery, these catalysts can be mixed in the absence of a solvent and under suitable inert anhydrous conditions with an another substance that is inert or sufficiently inert to the catalyst as to enable the formation of an undissolved mixture which can be stored and shipped in much the same way as the same catalyst in isolated condition. In other words, neither the catalyst nor the other substance is dissolved in whole or in part in an ancillary solvent in forming such mixture. A few illustrative examples of substances which can be mixed with the catalyst, such as by dry blending under suitable inert anhydrous conditions, are (i) particulate or powdery dry, anhydrous silica, alumina, or silica-alumina; (ii) dry particles of a polyolefin polymer; or (iii) any other dry material which is inert to the catalyst and which does not dissolve (solvate) the catalyst, e.g., dry glass beads, chopped glass fiber, inert metal whiskers, dry carbon fibers, or the like.

Except when being subjected to an optional finishing procedure or optional mixing procedure with one or more inert substances, the catalyst composition of this first aspect of the invention, whether in isolated form, in the form of a solvent-free mixture with one or more inert substances, or supported on a catalyst support, is stored or transported or otherwise handled under or in a dry, anhydrous environment or atmosphere. The term “isolated” is being used herein to denote that no other substance is intentionally mixed with or placed in contact with the catalytic composition except for an inert atmosphere (or vacuum) and a suitable container.

In the practice of this invention the stable isolated catalyst compositions, the stable supported catalyst compositions, and the solvent-free mixtures of catalyst composition and inert substance(s) can be stored and transported by the manufacturer, and stored by the consumer, all without need for refrigeration, and then used as an active preformed catalyst in the polymerization of polymerizable olefinic compounds. Thus the operations of both the catalyst manufacturer and the consumer, when different parties, can both be greatly simplified. This can be accomplished pursuant to this invention by maintaining (i) the isolated catalyst composition, (ii) an undissolved mixture of the catalyst composition with one or more other inert materials that do not dissolve the catalyst composition, or (iii) a supported catalyst composition of this invention, in a dry inert atmosphere from the time of the removal or separation of the catalyst composition from solution to the time of its use. It will be understood and appreciated, however, that one exposure of the catalyst composition to a small amount of moisture and/or air or more than one exposure of the catalyst composition to a small total amount of moisture and/or air, which amount or total amount does not destroy substantially an entire quantity of the isolated catalyst composition, can be tolerated and thus is not excluded from the scope of this invention. But of course, one should try to minimize the extent of such exposure(s) as much as is practicable under any given set of circumstances. This is simply a matter of common sense. Where one or more such exposures, inadvertent or otherwise, has occurred, and there is a possibility that the entire quantity of the catalyst has not been harmed, a representative sample of such previously-exposed catalyst should be tested for catalytic activity. If the test indicates that the previously-exposed catalyst remains sufficiently catalytically active, it would seem reasonable to keep the remainder of the previously-exposed catalyst under proper storage conditions for future use. On the other hand, if the test indicates that the previously-exposed catalyst no longer possesses sufficient catalytic activity, then it would seem reasonable to discard the remainder of the previously-exposed catalyst.

Accordingly, the first aspect of this invention utilizes all of the new compounds and all of the new processes of the Parent Application. The added features of this invention are to recover the catalyst composition (catalytic compound) after its preparation, optionally subject the catalyst composition to one or more finishing procedures and/or optionally mix the catalyst composition with one or more inert substances under suitable inert anhydrous conditions, and store the catalyst composition by itself, in supported form or as a solvent-free mixture with one or more inert substances under suitable conditions which minimize exposure to moisture and air (oxygen) as much as reasonably possible.

Thus in one of its embodiments, the first aspect of this invention provides a compound which comprises a cation derived from d-block or f-block metal compound by loss of a leaving group and an aluminoxate anion derived by transfer of a proton from a stable or metastable hydroxyaluminoxane to said leaving group, wherein such compound is in undissolved form in a dry, inert atmosphere or environment. Preferably the compound in such atmosphere or environment is in isolated form or is in supported form on a catalyst support.

Another embodiment of the first aspect of this invention is a compound which comprises a cation derived from a d-block or f-block metal compound by loss of a leaving group and an aluminoxate anion devoid of said leaving group, wherein the compound comprised of such cation and aluminoxate anion is in undissolved form in a dry, inert atmosphere or environment. Preferably the compound in such atmosphere or environment is in isolated form or is in supported form on a catalyst support.

A further embodiment is a compound which comprises a cation derived from a d-block or f-block metal compound by loss of a leaving group transformed into a neutral hydrocarbon, and an aluminoxate anion derived by loss of a proton from a hydroxyaluminoxane having, prior to said loss, at least one aluminum atom having a hydroxyl group bonded thereto, wherein the compound comprised of such cation and aluminoxate anion is in undissolved form except during one or more optional finishing procedures, if and when any such finishing procedure is performed. In addition, the compound is kept in a dry, inert atmosphere during a storage period. Preferably the compound in such atmosphere or environment is in isolated form or is in supported form on a catalyst support.

The compounds of each of the above embodiments of the first aspect of this invention can be used as a catalyst either in the solid state or in solution. The stability of the compound when in solution is sufficient to enable the compound to perform as a homogeneous catalyst.

Still another embodiment of the first aspect of this invention is a process which comprises contacting a d-block or f-block metal compound having at least two leaving groups with a hydroxyaluminoxane in which at least one aluminum atom has a hydroxyl group bonded thereto so that one of said leaving groups is lost; recovering the resultant metal-containing compound so formed; and storing such recovered compound (preferably in isolated form or in supported form on a catalyst support) in an anhydrous, inert atmosphere or environment. Such compound is maintained in undissolved form except during one or more optional finishing procedures, if and when any such finishing procedure is performed.

Also provided as another embodiment of the first aspect of this invention is a process which comprises donating a proton from an aluminoxane to a leaving group of a d-block or f-block metal compound to form a compound composed of a cation derived from said metal compound and an aluminoxate anion devoid of said leaving group; recovering the compound composed of such cation and aluminoxate anion; storing such recovered compound (preferably in isolated form or in supported form on a catalyst support) in an anhydrous, inert atmosphere or environment; and maintaining such compound in undissolved form except during one or more optional finishing procedures, if and when any such finishing procedure is performed.

Another embodiment is a process which comprises interacting a d-block or f-block metal compound having two leaving groups and a hydroxyaluminoxane having at least one aluminum atom that has a hydroxyl group bonded thereto to form a compound composed of a cation through loss of a leaving group which is transformed into a neutral hydrocarbon, and an aluminoxate anion derived by loss of a proton from said hydroxyaluminoxane; recovering the compound composed of such cation and aluminoxate anion; storing such recovered compound (preferably in isolated form or in supported form on a catalyst support) in an anhydrous, inert atmosphere or environment; and maintaining such compound in undissolved form except during one or more optional finishing procedures, if and when any such finishing procedure is performed.

Second Aspect

The second aspect of this invention is that discovery that hydroxyaluminoxanes can be converted into novel, solid compositions of matter using a carrier material, so as to drastically increase the lifetime of the hydroxy group(s) in the composition (i.e., reduce the composition OH-decay rate), even at room temperature, while at the same time reducing, if not eliminating, reactor fouling.

Thus, one embodiment of the second aspect of this invention provides a composition in the form of one or more individual solids, which composition is formed from components comprised of (i) a hydroxyaluminoxane and (ii) a carrier material compatible with said hydroxyaluminoxane and in the form of one or more individual solids, said composition having a reduced OH-decay rate relative to the OH-decay rate of (i).

The second aspect of this invention also provides in another embodiment a composition which comprises a hydroxyaluminoxane supported on a solid support.

Yet another embodiment of the second aspect of the present invention is a process comprising converting a hydroxyaluminoxane into a composition in the form of one or more individual solids by bringing together (i) a hydroxyaluminoxane and (ii) a carrier material compatible with said hydroxyaluminoxane and in the form of one or more individual solids, whereby the rate of OH-decay for said composition is reduced relative to the rate of OH-decay of (i).

Still another embodiment of the second aspect of the present invention is a supported activated catalyst composition formed by bringing together (A) a composition in the form of one or more individual solids, which composition is formed from components comprised of (i) a hydroxyaluminoxane and (ii) a carrier material compatible with said hydroxyaluminoxane and in the form of one or more individual solids, said composition of (A) having a reduced OH-decay rate relative to the OH-decay rate of (i); and (B) a d- or f-block metal compound having at least one leaving group on a metal atom thereof.

The second aspect of this invention also provides a process of preparing a supported activated catalyst, which process comprises bringing together (A) a composition in the form of one or more individual solids formed by bringing together (i) a hydroxyaluminoxane and (ii) a carrier material compatible with said hydroxyaluminoxane and in the form of one or more individual solids, whereby the rate of OH-decay for said composition is reduced relative to the rate of OH-decay of (i); and (B) a d- or f-block metal compound having at least one leaving group on a metal atom thereof.

In another embodiment of the second aspect of this invention, an olefin polymerization process is provided which comprises bringing together in a polymerization reactor or reaction zone (1) at least one polymerizable olefin and (2) a supported activated catalyst composition which is in accordance with this invention.

Still another embodiment of the second aspect of this invention is a catalyst composition formed by bringing together (A) a hydroxyaluminoxane and (B) rac-ethylenebis(1-indenyl)zirconium dimethyl.

A further embodiment of the second aspect of the invention provides a process for the production of a supported hydroxyaluminoxane which comprises bringing together (i) an aluminum alkyl in an inert solvent, (ii) a water source, and (iii) a carrier material, under hydroxyaluminoxane-forming reaction conditions.

Still another embodiment is a method of forming an olefin polymerization catalyst, which method comprises introducing into a reactor or a reaction zone (A) a hydroxyaluminoxane and (B) a d- or f-block metal compound in proportions such that an active olefin polymerization catalyst is formed. In this embodiment, the hydroxyaluminoxane preferably is fed in the form of (i) a solution of the hydroxyaluminoxane in an inert solvent or in a liquid polymerizable olefinic monomer, or both; (ii) a slurry of the hydroxyaluminoxane in an inert diluent or in a liquid polymerizable olefinic monomer; (iii) unsupported solid particles; or (iv) one or more solids on a carrier material or catalyst support; or (v) any combination of two or more of (i), (ii), (iii), and (iv). More preferably, the hydroxyaluminoxane will be fed in the form of one or more solids on a carrier material suspended in an inert viscous liquid, e.g., mineral oil. Similarly, the d- or f-block metal compound preferably is fed in the form of (i) undiluted solids or liquid, or (ii) a solution or slurry of the d- or f-block metal compound in an inert solvent or diluent, or in a liquid polymerizable olefinic monomer, or in a mixture of any of these. More preferably, the d- or f-block metal compound will be fed in the form of a solution or slurry of the metal compound in an inert solvent or diluent. It is also preferred that the catalyst be formed from only components (A) and (B). The introduction of (A) and (B) into the reactor or reaction zone can proceed in any given order or sequence, or can proceed concurrently. Also, the introduction of (A) and (B) into the reactor or reaction zone can proceed continuously or intermittently. Preferably, the metal compound is fed into the hydroxyaluminoxane, and more preferably the metal compound in the form of a solution or slurry in an inert solvent or diluent will be fed to the hydroxyaluminoxane in the form of one or more solids on a carrier material suspended in an inert viscous liquid.

As another of its embodiments, the second aspect of this invention also provides, in a process for the catalytic polymerization of at least one olefin in a polymerization reaction vessel or reaction zone, the improvement which comprises introducing into the reaction vessel or reaction zone catalyst components comprising (A) a hydroxyaluminoxane and (B) a d- or f-block metal compound, in proportions such that said at least one olefin is polymerized. Components (A) and (B) can be introduced into the polymerization reactor vessel or zone as separate feeds, either continuously or intermittently, and either concurrently or in any sequence. Alternatively, they can be brought together and allowed to interact with each other for a suitable period of time with the resultant composition then being introduced into the polymerization reactor or zone. Other polymerization components, e.g., aluminum alkyl or ordinary hydroxyaluminoxane, can be introduced before, during, or after the introduction of (A) and (B) or either of them or of a preformed catalyst formed by interaction between (A) and (B). The forms in which the hydroxyaluminoxane and the d- or f-block metal compound are fed into the polymerization reactor or zone can be any of those described in the immediately preceding paragraph.

Third Aspect

The third aspect of this invention is the discovery that hydroxyaluminoxanes can be converted into novel compositions of matter in gelatinous form, or in solid form formed from the gelatinous form, or in both forms, so as to drastically increase the lifetime of the hydroxy group(s) in the composition (i.e., reduce the composition OH-decay rate), even at room temperature, while at the same time reducing, if not eliminating, reactor fouling. When the term “gelatinous” is used herein, it denotes that the composition is in a jelly-like form which either may be composed of a geled solution or suspension formed from the hydroxyaluminoxane and of sufficiently viscous consistency to act like a gel or jelly.

Thus, this invention provides in one of the embodiments of this third aspect, a composition of matter in gelatinous form, or in solid form derived therefrom, or both, formed by bringing together at least (i) a hydroxyaluminoxane in an inert solvent and (ii) a treating agent, such that the composition has a reduced OH-decay rate as compared to the OH-decay rate of the hydroxyaluminoxane. Without being bound to theory, it is believed that the gelantinous continous phase is a matrix formed from the hydroxyaluminoxane upon being exposed to sufficinet amounts of the treating agent. Another embodiment of this aspect of the invention is a solid composition of matter formed by removing said inert solvent from the composition of matter in gelatinous form.

In another embodiment, a gelantinous composition is comprised of hydroxyaluminoxane and characterized by having an OH-decay rate which is reduced as compared to the OH-decay rate of the hydroxyaluminoxane in a liquid form.

Another embodiment of the third aspect of this invention provides a process comprising converting a hydroxyaluminoxane into a gelatinous composition of matter by bringing together (i) said hydroxyaluminoxane in an inert solvent and (ii) a treating agent compatible with said hydroxyaluminoxane, whereby the rate of OH-decay for said composition of matter is reduced relative to the rate of OH-decay of (i).

Still another embodiment of the invention yields an activated catalyst composition formed by bringing together (A) a gelantinous composition of matter, or a solid composition of matter formed therefrom, or both, said gelantinous composition of matter being formed by bringing together at least (i) a hydroxyaluminoxane in an inert solvent and (ii) a treating agent compatible with said hydroxyaluminoxane, said gelantinous composition of (A) having a reduced OH-decay rate relative to the OH-decay rate of (i); and (B) a d- or f-block metal compound having at least one leaving group on a metal atom thereof.

The third aspect of this invention also provides an embodiment which is a process of preparing an activated olefin polymerization catalyst composition, which process comprises bringing together (A) a gelantinous composition of matter, or a solid composition of matter formed therefrom, or both, said gelatinous composition of matter being formed by bringing together at least (i) a hydroxyaluminoxane in an inert solvent and (ii) a treating agent compatible with said hydroxyaluminoxane, whereby the rate of OH-decay for said composition is reduced relative to the rate of OH-decay of (i); and (B) a d- or f-block metal compound having at least one leaving group on a metal atom thereof.

A further embodiment of the third aspect of this invention is an olefin polymerization process which comprises bringing together in a polymerization reactor or reaction zone at least (1) one or more polymerizable olefins and (2) an activated catalyst composition which is in accordance with the present invention, so as to form a polymer.

Yet another embodiment of the third aspect of this invention is a process which comprises bringing together at least (i) an aluminum alkyl in an inert solvent and (ii) a water source, under hydroxyaluminoxane-forming reaction conditions and using an amount (ii) sufficient to cause a gelatinous composition of matter to form.

The above and other embodiments, features, and advantages of this invention will become still further apparent from the ensuing description and appended claims.

### BRIEF DESCRIPTION OF THE DRAWINGS

FIGS. 1-5 are FIGS. 1-5 from U.S. Pat. No. 6,160,145.

FIG. 6 is a graph illustrating the change in infrared —OH absorption over time at room temperature for hydroxyisobutylaluminoxane (HO-IBAO) and for hydroxyisooctylaluminoxane (HO-IOAO).

FIG. 7 is a graph illustrating the change in infrared —OH absorption over time at −10° C. for HO-IBAO and for HO-IOAO.

FIG. 8 is a DRIFTS subtraction spectrum of DO-IBAO/silica and HO-IBAO/silica.

FIG. 9 is a H¹-nmr spectrum of the distillate from BnMgCl+DO-IBAO/silica.

FIG. 10 is a graph illustrating the change in the number of OH groups per 100 aluminum atoms over time at room temperature for HO-IBAO at −10° C., HO-IBAO/silica(1) and HO-IBAO/silica(2).

FIG. 11 are superimposed FT-infrared spectra of HO-IBAO(1.2) and soluble HO-IBAO (1.0).

FIG. 12 are variable temperature DRIFTS spectra of HO-IBAO(1.2) gel.

### FURTHER DETAILED DESCRIPTION OF THE INVENTION

The following detail description of the invention will be made with reference to the three primary aspects of the invention, with the proviso that the Experimental Section set forth below is presented with respect to all aspects of the invention.

First and Second Aspects

Hydroxyaluminoxane Reactants

Unlike catalyst compositions formed from a transition, lanthanide or actinide metal compound (hereinafter “d- or f-block metal compound”) and MAO or other previously recognized aluminoxane co-catalyst species, the catalyst compositions of U.S. Pat. No. 6,160,145 and those described herein are formed from a hydroxyaluminoxane. The hydroxyaluminoxane has a hydroxyl group bonded to at least one of its aluminum atoms. To form these hydroxyaluminoxanes, a sufficient amount of water is reacted with an alkyl aluminum compound to result in formation of a compound having at least one HO-Al group and having sufficient stability to allow reaction with a d- or f-block organometallic compound to form a hydrocarbon.

The alkyl aluminum compound used in forming the hydroxyaluminoxane reactant can be any suitable alkyl aluminum compound other than trimethylaluminum. Thus at least one alkyl group has two or more carbon atoms. Preferably each alkyl group in the alkyl aluminum compound has at least two carbon atoms. More preferably each alkyl group has in the range of 2 to 24, and still more preferably in the range of 2 to 16 carbon atoms. Particularly preferred are alkyl groups that have in the range of 2 to 9 carbon atoms each. The alkyl groups can be cyclic (e.g., cycloalkyl, alkyl-substituted cycloalkyl, or cycloalkyl-substituted alkyl groups) or acyclic, linear or branched chain alkyl groups. Preferably the alkyl aluminum compound contains at least one, desirably at least two, and most preferably three branched chained alkyl groups in the molecule. Most preferably each alkyl group of the aluminum alkyl is a primary alkyl group, i.e., the alpha-carbon atom of each alkyl group carries two hydrogen atoms.

Suitable aluminum alkyl compounds which may be used to form the hydroxyaluminoxane reactant include dialkylaluminum hydrides and aluminum trialkyls. Examples of the dialkylaluminum hydrides include diethylaluminum hydride, dipropyl aluminum hydride, diisobutylaluminum hydride, di(2,4,4-trimethylpentyl)aluminum hydride, di(2-ethylhexyl)aluminum hydride, di(2-butyloctyl)aluminum hydride, di(2,4,4,6,6-pentamethylheptyl)aluminum hydride, di(2-hexyldecyl)aluminum hydride, dicyclopropylcarbinylaluminum hydride, dicyclohexylaluminum hydride, dicyclopentylcarbinylaluminum hydride, and analogous dialkylaluminum hydrides. Examples of trialkylaluminum compounds which may be used to form the hydroxyaluminoxane include triethylaluminum, tripropylaluminum, tributylaluminum, tripentylaluminum, trihexylaluminum, triheptylaluminum, trioctylaluminum, and their higher straight chain homologs; triisobutylaluminum, tris(2,4,4-trimethylpentyl)aluminum, tri-2-ethylhexylaluminum, tris(2,4,4,6,6-pentamethylheptyl)aluminum, tris(2-butyloctyl)aluminum, tris(2-hexyldecyl)aluminum, tris(2-heptylundecyl)aluminum, and their higher branched chain homologs; tri(cyclohexylcarbinyl)aluminum, tri(2-cyclohexylethyl)aluminum and analogous cycloaliphatic aluminum trialkyls. Triisobutylaluminum has proven to be an especially desirable alkyl aluminum compound for producing a hydroxyaluminoxane.

To prepare the hydroxyaluminoxane a solution of the alkyl aluminum compound in an inert solvent, preferably a saturated or aromatic hydrocarbon, is treated with controlled amounts of water while maintaining the vigorously agitated reaction mixture at low temperature, e.g., below 0° C. When the exothermic reaction subsides, the reaction mixture is stored at a low temperature, e.g., below 0° C. until used in forming a compound of this invention. When preparing a hydroxyaluminoxane from a low molecular weight alkylaluminum compound, the reaction mixture can be subjected, if desired, to stripping under vacuum at a temperature below room temperature to remove some lower alkane hydrocarbon co-product formed during the reaction. However, such purification is usually unnecessary as the lower alkane co-product is merely an innocuous impurity.

Among suitable procedures for preparing hydroxyaluminoxanes for use in practice of this invention, is the method described by Ikonitskii et al., Zhurnal Prikladnoi Khimii, 1989, 62(2), 394-397; and the English language translation thereof available from Plenum Publishing Corporation, copyright 1989, as Document No. 0021-888X/89/6202-0354.

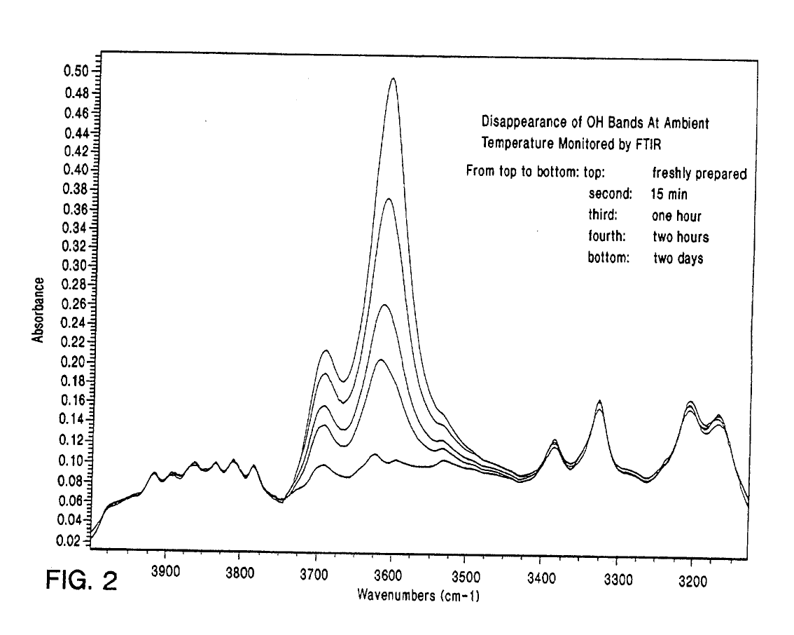

It is very important to slow down the premature loss of its hydroxyl group content sufficiently to maintain a suitable level of OH groups until the activation reaction has been effected. One way to accomplish this is to maintain the temperature of the hydroxyaluminoxane product solution sufficiently low. This is demonstrated by the data presented graphically in FIG. 2 which shows the loss of hydroxyl groups from hydroxyisobutylaluminoxane at ambient room temperature in an IR cell. If, on the other hand, the same hydroxyaluminoxane solution is stored in a freezer at −10° C., the rate of hydroxyl group loss is reduced to such a degree that the time scale for preserving the same amount of hydroxyl groups can be lengthened from one to two hours at ambient room temperature to one to two weeks at −10° C. If the hydroxyl group content is lost, the compound reverts to an aluminoxane which is incapable of forming the novel ionic highly active catalytic compounds of this invention.

It is also important when preparing the hydroxyaluminoxanes to use enough water to produce the hydroxyaluminoxane, yet not so much water as will cause its destruction. Typically the water/aluminum mole ratio is in the range of 0.5/1 to 1.2/1, and preferably in the range of 0.8/1 to 1.1/1. At least in the case of hydroxyisobutylaluminoxane, these ratios typically result in the formation of hydroxyaluminoxane having at least one hydroxyl group for every seven aluminum atoms in the overall product. The hydroxyisobutylaluminoxane is essentially devoid of unreacted triisobutylaluminum.

However, in the second aspect of this invention, it now has been discovered that the rate of OH-decay (i.e., the rate at which OH groups disassociate so as to reduce the number of OH groups present in the molecule) for the above-described hydroxyalumioxane may be drastically and surprisingly reduced by converting hydroxyaluminoxane into a composition in the form of one or more individual solids having an OH-decay rate which is reduced relative to the OH-decay rate of the hydroxyaluminoxane. Such a composition is formed by bringing together the hydroxyaluminoxane and a carrier material which is compatible with the hydroxyaluminoxane and which is in the form of one or more individual solids. In bringing these two components together, it is preferred that the hydroxyaluminoxane becomes supported upon the carrier material. Typically, the rate of OH-decay for the composition so formed is reduced by a factor of at least 5, and more preferably at least 10, as compared to the rate of OH-decay of the hydroxyaluminoxane. The composition formed from the hydroxyaluminoxane and carrier material itself may be used to form active polymerization catalysts of this invention. Such compositions remain active as a Brønsted acid for a surprisingly greater period of time as compared to that of the hydroxyaluminoxane.

When it is stated herein with respect to the second aspect of this invention that the composition so formed or the carrier material is “in the form of one or more individual solids,” it is meant that the composition or carrier material, as the case may be, is solid matter, regardless of whether it takes the form of a single solid slab or unitary piece of matter in solid form, or the form of a mass made up of a plurality of unitary pieces of matter in solid form, e.g., particles, pellets, micropellets, beads, crystals, agglomerates, or the form of some other macromolecular structure. Preferably, the carrier material is in particulate form, and more preferably is in particulate form having a surface area of typically at least 20, preferably at least 30, and most preferably from at least 50 m²/g, which surface area can range typically from 20 to 800, preferably from 30 to 700, and most preferably from 50 to 600 m²/g. It is also preferred that the carrier material particulate have a bulk density of typically at least 0.15, preferably at least 0.20, and most preferably at least 0.25 g/mL, which bulk density can range typically from 0.15 to 1, preferably from 0.20 to 0.75, and most preferably from 0.25 to 0.45 g/mL. Preferably, the carrier particulate has an average pore diameter of typically from 30 to 300, and most preferably from 60 to 150 Angstroms. The carrier particulate also preferably has a total pore volume of typically 0.10 to 2.0, more preferably from 0.5 to 1.8, and most preferably from 0.8 to 1.6 cc/g. The average particle size and its distribution will be dictated and controlled by the type of polymerization reaction contemplated for the catalyst composition. As a generalization, the average particle size will be in the range of from 4 to 250, and preferably in the range of 8 to 100 microns. However, with respect to specific processes, solution polymerization processes, for example, typically can employ an average particle size in the range of 1 to 10 microns, while a continuous stirred tank reactor slurry polymerization typically can employ an average particle size in the range of 8 to 50 microns, a loop slurry polymerization typically can employ an average particle size in the range of 10 to 150 microns, and a gas phase polymerization typically can employe an average particle size in the range of 20 to 120 microns. Other sizes may also be preferred under varying circumstances. When the carrier material is formed by spray drying, it is also preferable that typically at least 80, more preferably at least 90, and most preferably at least 95 vol. percent of that fraction of the carrier particles smaller than the D₉₀ of the entire carrier particulate particle size distribution possesses microspheroidal shape (i.e., morphology). Also, when it is said that the carrier material is “compatible” with the hydroxyaluminoxane, it is meant that the carrier material is capable of coming into proximity or contact with, or being mixed with or otherwise placed in the presence of, the hydroxyaluminoxane without adversely affecting the ability of the hydroxyaluminoxane to activate the metal compound elsewhere described herein to form the polymerization catalysts of this invention.

The carrier material used in the practice of this second aspect of invention is preferably a solid support. Non-limiting examples of such solid supports will include particulate inorganic catalyst supports such as, e.g., inorganic oxides (e.g., silica, silicates, silica-alumina, alumina) clay, clay minerals, ion exchanging layered compounds, diatomaceous earth, zeolites, magnesium chloride, talc, and the like, including combinations of any two or more of the same, and particulate organic catalyst supports such as, e.g., particulate polyethylene, particulate polypropylene, other polyolefin homopolymers or copolymers, and the like, including combinations of any two or more of the same. Particulate inorganic catalyst supports are preferred. It is also preferred that the support be anhydrous or substantially anhydrous. More preferred is particulate calcined silica, which is optionally pretreated in conventional manner with a suitable aluminum alkyl, e.g., triethyl aluminum. In certain applications, it may be preferred to suspend the carrier material in a viscous inert liquid, e.g., mineral oil. The viscosity of such inert liquid can vary depending upon the carrier material involved, but such viscous inert material is most preferably viscous enough to retain the carrier material (and any material supported thereupon) in suspension over a desired period of time or at least to permit of resuspension of the support (and any material supported thereupon) with agitation (e.g., stirring) after settling. Exemplary viscous inert liquid will preferably have a viscosity in the range of 1 to 2000 centipoise, and more preferably in the range of 200 to 1500 centipoise, at ambient temperature.

With respect to the second aspect of this invention, the amount of hydroxyaluminoxane in the composition which includes a carrier material typically will be 5 to 50 weight percent, preferably 10 to 40 weight percent, and more preferably 20 to 30 weight percent, hydroxyaluminoxane based upon the total weight of the composition, with the balance being made up of the carrier material.

The reaction conditions under which the carrier material and the hydroxyaluminoxane may be brought together in the second aspect of this invention may vary widely, but typically will be characterized with a temperature in the range of −20 to 100° C., using superatmospheric, subatmospheric or atmospheric pressure (so long as the desired product is formed) and an inert atmopshere or environment. These components may be brought together in any of a variety of ways, including, e.g., by feeding the hydroxyaluminoxane and the carrier material concurrently or sequentially in any sequence, and mixing the components together, preferably in an inert liquid medium, or by otherwise mixing or contacting these components with each other, again preferably in an inert liquid medium. The liquid medium can be separately fed to the mixing vessel before, during, and/or after feeding or otherwise introducing the hydroxyaluminoxane and/or the carrier material. Similarly, the hydroxyaluminoxane can be fed as a solution or slurry in the liquid medium, and/or, the carrier material when in particulate form can be fed as a slurry in the liquid medium to thereby provide all or a part of the total liquid medium being used. Such procedures can be conducted either in batch, continuously or intermittently. Preferably, the carrier material and the hydroxyaluminoxane will be brought together in the presence of an inert solvent in which the hydroxyaluminoxane is dissolved, e.g., in an inert organic solvent such as a saturated aliphatic or cycloaliphatic hydrocarbon, or an aromatic hydrocarbon, or a mixture of any two or more such hydrocarbons.

Again in the second aspect of this invention, for quantitative purposes with respect to the number of hydroxyl groups present in the hydroxyaluminoxane or in the composition made therefrom, a deuterium-labeled DO-hydroxyaluminoxane-carrier preferably is used when the carrier material includes hydroxyl groups (e.g., silica). Typically, samples will be stored at room temperature in a dry box and sampled periodically for quantitative analysis to determine the rate of OH-decay at given points in time. A typical procedure with respect to deuterium-labeled hydroxyisobutylaluminoxane-silica is described below in Example 28. This procedure will preferably be employed to quantify the hydroxyl groups (as DO— per 100 aluminum atoms) present in the composition at or near the time of fresh preparation (i.e., time zero), and at one or more intervals of time thereafter, preferably at 48 hours or more preferably at 72 hours following preparation of the sample materials. The change in the number of hydroxyl groups at the selected time interval from that at time zero, divided by the amount of time, will be the OH-decay rate. When the carrier material does not include hydroxyl groups, or when the sample material is unsupported hydroxyaluminoxane, this same procedure may be employed but without deuterium labeling.

The co-catalyst compositions of the second aspect of this invention which are formed from the hydroxyaluminoxane and the carrier material may be formed and isolated prior to use as a catalyst component, or they may be formed in situ, such as, e.g., during the process of production of the hydroxyaluminoxane itself. Accordingly, these compositions may be formed by addition of the carrier material during the synthesis of hydroxyaluminoxane. Thus, for example, the carrier material may be introduced at any point during the synthesis processes described hereinabove for the hydroxyaluminoxane, so as to bring an aluminum alkyl in solution together with a water source and the carrier material under hydroxyaluminoxane-forming reaction conditions. Besides free water, other non-limiting examples of a suitable water source include hydrates of alkali or alkaline earth metal hydroxides such as, for example, lithium, sodium, potassium, barium, calcium, magnesium, and cesium hydroxides (e.g., sodium hydroxide mono- and dihydrate, barium hydroxide octahydrate, potassium hydroxide dihydrate, cesium hydroxide monohydrate, lithium hydroxide monohydrate, and the like), aluminum sulfate, certain hydrated catalyst support materials (e.g., un-dehydrated silica), as well as mixtures of any two or more of the foregoing. The reaction conditions for this in situ formation will typically be the same as those reactions conditions taught herein for forming the hydroxyaluminoxane generally.

When forming these co-catalyst compositions from the hydroxyaluminoxane and the carrier material, it is preferred that the hydroxyaluminoxane have less than 25 OH groups per 100 aluminum atoms, and even more preferred that they have no more than 15 OH groups per 100 aluminum atoms. In certain other embodiments of this invention, it is also preferred that the composition so made be substantially insoluble in an inert organic solvent such as various hydrocarbons, e.g., saturated aliphatic or cycloaliphatic hydrocarbons.

The compositions formed from a hydroxyaluminoxane in accordance with this second aspect of the present invention may be employed as the olefin polymerization co-catalyst in place of the less stable hydroxyaluminoxane, to provide a surprisingly more stable yet equally effective co-catalyst and catalyst composition in commercial applications.

d- or f-Block Metal Compound

Various d- and f-block metal compounds may be used in forming the catalytically active compounds of this invention. The d-block and f-block metals of this reactant are the transition, lanthanide and actinide metals. See, for example, the Periodic Table appearing on page 225 of Moeller, et al., Chemistry, Second Edition, Academic Press, Copyright 1984. As regards the metal constituent, preferred are compounds of Fe, Co, Pd, and V. More preferred are compounds of the metals of Groups 4-6 (Ti, Zr, Hf, V, Nb, Ta, Cr, Mo, and W), and most preferred are the Group 4 metals, especially hafnium, and most especially zirconium.

A vital feature of the d- or f-block metal compound used in forming the ionic compounds of this invention is that it must contain at least one leaving group that forms a separate co-product by interaction with a proton from the hydroxyaluminoxane or that interacts with a proton from the hydroxyaluminoxane so as to be converted from a cyclic divalent group into an open chain univalent group bonded to the metal atom of the metallocene. Thus the activity of the chemical bond between the d- or f-block metal atom and the leaving group must be at least comparable to and preferably greater than the activity of the aluminum-carbon bond of the hydroxyaluminoxane. In addition, the basicity of the leaving group must be such that the acidity of its conjugate acid is comparable to or less than the acidity of the hydroxyaluminoxane. Univalent leaving groups that meet these criteria include hydride, hydrocarbyl and silanylcarbinyl (R₃SiCH₂—) groups, such as methyl, ethyl, vinyl, allyl, cyclohexyl, phenyl, benzyl, trimethylsilanylcarbinyl, amido, alkylamido, and substituted alkylamido. Of these, the methyl group is the most preferred leaving group. Suitable divalent cyclic groups that can serve as leaving groups by a ring opening mechanism whereby a cyclic group is converted into an open chain group that is still bonded to the metal atom of the metallocene include conjugated diene divalent anionic ligand groups such as a conjugated diene or a hydrocarbyl-, halocarbyl-, or silyl substituted derivative thereof, such conjugated diene anionic ligand groups having from 4 to 40 nonhydrogen atoms and being coordinated to the metal atom of the metallocene so as to form a metallocyclopentene therewith. Typical conjugated diene ligands of this type are set forth for example in U.S. Pat. No. 5,539,068.

Metallocenes make up a preferred class of d- and f-block metal compounds used in making the ionic compounds of this invention. These compounds are characterized by containing at least one cyclopentadienyl moiety pi-bonded to the metal atom. For use in this invention, the metallocene must also have bonded to the d- or f-block metal atom at least one leaving group capable of forming a stable co-product on interaction with a proton from the hydroxyaluminoxane. A halogen atom (e.g., a chlorine atom) bonded to such metal atom is incapable of serving as a leaving group in this regard in as much as the basicities of such halogen atoms are too low.

Such leaving groups may be prepared separately or in situ. For example, metallocene halides may be treated with alkylating agents such as dialkylaluminum alkoxides to generate the desired alkylmetallocene in situ. Reactions of this type are described for example in WO 95/10546.

Metallocene structures in this specification are to be interpreted broadly, and include structures containing 1, 2, 3 or 4 Cp or substituted Cp rings. Thus metallocenes suitable for use in this invention can be represented by the Formula I:

BₐCp_{b}ML_{c}X_{d} (I)

where Cp independently in each occurrence is a cyclopentadienyl-moiety-containing group which typically has in the range of 5 to 24 carbon atoms; B is a bridging group or ansa group that links two Cp groups together or alternatively carries an alternate coordinating group such as alkylaminosilylalkyl, silylamido, alkoxy, siloxy, aminosilylalkyl, or analogous monodentate hetero atom electron donating groups; M is a d- or f-block metal atom; each L is, independently, a leaving group that is bonded to the d- or f-block metal atom and is capable of forming a stable co-product on interaction with a proton from a hydroxyaluminoxane; X is a group other than a leaving group that is bonded to the d- or f-block metal atom; a is 0 or 1; b is a whole integer from 1 to 3 (preferably 2); c is at least 2; d is 0 or 1. The sum of b, c, and d is sufficient to form a stable compound, and often is the coordination number of the d- or f-block metal atom.

Cp is, independently, a cyclopentadienyl, indenyl, fluorenyl or related group that can π-bond to the metal, or a hydrocarbyl-, halo-, halohydrocarbyl-, hydrocarbylmetalloid-, and/or halohydrocarbylmetalloid-substituted derivative thereof. Cp typically contains up to 75 non-hydrogen atoms. B, if present, is typically a silylene (—SiR₂—), benzo (C₆H₄<), substituted benzo, methylene (—CH₂—), substituted methylene, ethylene (—CH₂CH₂—), or substituted ethylene bridge. M is preferably a metal atom of Groups 4-6, and most preferably is a Group 4 metal atom, especially hafnium, and most especially zirconium. L can be a divalent substituent such as an alkylidene group, a cyclometallated hydrocarbyl group, or any other divalent chelating ligand, two loci of which are singly bonded to M to form a cyclic moiety which includes M as a member. In most cases L is methyl. X, if present, can be a leaving group or a non-leaving group, and thus can be a halogen atom, a hydrocarbyl group (alkyl, cycloalkyl, alkenyl, cycloalkenyl, aryl, or aralkyl), hydrocarbyloxy, (alkoxy or aryloxy) siloxy, amino or substituted amino, hydride, acyloxy, triflate, and similar univalent groups that form stable metallocenes. The sum of b, c, and d is a whole number, and is often from 3-5. When M is a Group 4 metal or an actinide metal, and b is 2, the sum of c and d is 2, c being at least 1. When M is a Group 3 or Lanthanide metal, and b is 2, c is 1 and d is zero. When M is a Group 5 metal, and b is 2, the sum of c and d is 3, c being at least 2.

Also incorporated in this invention are compounds analogous to those of Formula I where one or more of the Cp groups are replaced by cyclic unsaturated charged groups isoelectronic with Cp, such as borabenzene or substituted borabenzene, azaborole or substituted azaborole, and various other isoelectronic Cp analogs. See for example Krishnamurti, et al., U.S. Pat. Nos. 5,554,775 and 5,756,611.

In one preferred group of metallocenes, b is 2, i.e., there are two cyclopentadienyl-moiety containing groups in the molecule, and these two groups can be the same or they can be different from each other.

Another sub-group of useful metallocenes which can be used in the practice of this invention are metallocenes of the type described in WO 98/32776 published Jul. 30, 1998. These metallocenes are characterized in that one or more cyclopentadienyl groups in the metallocene are substituted by one or more polyatomic groups attached via a N, O, S, or P atom or by a carbon-to-carbon double bond. Examples of such substituents on the cyclopentadienyl ring include —OR, —SR, —NR₂, —CH═, —CR═, and —PR₂, where R can be the same or different and is a substituted or unsubstituted C₁-C₁₆ hydrocarbyl group, a tri-C₁-C₈ hydrocarbylsilyl group, a tri-C₁-C₈ hydrocarbyloxysilyl group, a mixed C₁-C₈ hydrocarbyl and C₁-C₈ hydrocarbyloxysilyl group, a tri-C₁-C₈ hydrocarbylgermyl group, a tri-C₁-C₈ hydrocarbyloxygermyl group, or a mixed C₁-C₈ hydrocarbyl and C₁-C₈ hydrocarbyloxygermyl group.

Examples of metallocenes to which this invention is applicable include such compounds as:

bis(methylcyclopentadienyl)titanium dimethyl;

bis(methylcyclopentadienyl)zirconium dimethyl;

bis(n-butylcyclopentadienyl)zirconium dimethyl;

bis(dimethylcyclopentadienyl)zirconium dimethyl;

bis(diethylcyclopentadienyl)zirconium dimethyl;

bis(methyl-n-butylcyclopentadienyl)zirconium dimethyl;

bis(n-propylcyclopentadienyl)zirconium dimethyl;

bis(2-propylcyclopentadienyl)zirconium dimethyl;

bis(methylethylcyclopentadienyl)zirconium dimethyl;

bis(indenyl)zirconium dimethyl;

bis(methylindenyl)zirconium dimethyl;

dimethylsilylenebis(indenyl)zirconium dimethyl;

dimethylsilylenebis(2-methylindenyl)zirconium dimethyl;

dimethylsilylenebis(2-ethylindenyl)zirconium dimethyl;

dimethylsilylenebis(2-methyl-4-phenylindenyl)zirconium dimethyl;

1,2-ethylenebis(indenyl)zirconium dimethyl;

1,2-ethylene bis(methylindenyl)zirconium dimethyl;

2,2-propylidenebis(cyclopentadienyl)(fluorenyl)zirconium dimethyl;

dimethylsilylenebis(6-phenylindenyl)zirconium dimethyl;

bis(methylindenyl)zirconium benzyl methyl;

ethylenebis[2-(tert-butyldimethylsiloxy)-1-indenyl]zirconium dimethyl;

dimethylsilylenebis(indenyl)chlorozirconium methyl;

5-(cyclopentadienyl)-5-(9-fluorenyl)1-hexene zirconium dimethyl;

dimethylsilylenebis(2-methylindenyl)hafnium dimethyl;

dimethylsilylenebis(2-ethylindenyl)hafnium dimethyl;

dimethylsilylenebis(2-methyl-4-phenylindenyl)hafnium dimethyl;

2,2-propylidenebis(cyclopentadienyl)(fluorenyl)hafnium dimethyl;

bis(9-fluorenyl)(methyl)(vinyl)silane zirconium dimethyl;

bis(9-fluorenyl)(methyl)(prop-2-enyl)silane zirconium dimethyl;

bis(9-fluorenyl)(methyl)(but-3-enyl)silane zirconium dimethyl;

bis(9-fluorenyl)(methyl)(hex-5-enyl)silane zirconium dimethyl;

bis(9-fluorenyl)(methyl)(oct-7-enyl)silane zirconium dimethyl;

(cyclopentadienyl)(1-allylindenyl)zirconium dimethyl;

bis(1-allylindenyl)zirconium dimethyl;

(9-(prop-2-enyl)fluorenyl)(cyclopentadienyl)zirconium dimethyl;

(9-(prop-2-enyl)fluorenyl)(pentamethylcyclopentadienyl)zirconium dimethyl;

bis(9-(prop-2-enyl)fluorenyl)zirconium dimethyl;

(9-(cyclopent-2-enyl)fluorenyl)(cyclopentadienyl)zirconium dimethyl;

bis(9-(cyclopent-2-enyl)(fluorenyl)zirconium dimethyl;

5-(2-methylcyclopentadienyl)-5(9-fluorenyl)-1-hexene zirconium dimethyl;

1-(9-fluorenyl)-1-(cyclopentadienyl)-1-(but-3-enyl)-1-(methyl)methane zirconium dimethyl;

5-(fluorenyl)-5-(cyclopentadienyl)-1-hexene hafnium dimethyl;

(9-fluorenyl)(1-allylindenyl)dimethylsilane zirconium dimethyl;

1-(2,7-di(alpha-methylvinyl)(9-fluorenyl)-1-(cyclopentadienyl)-1,1-dimethylmethane zirconium dimethyl;

1-(2,7-di(cyclohex-1-enyl)(9-fluorenyl))-1-(cyclopentadienyl)-1,1-methane zirconium dimethyl;

5-(cyclopentadienyl)-5-(9-fluorenyl)-1-hexene titanium dimethyl;

5-(cyclopentadienyl)-5-(9-fluorenyl) 1-hexene titanium dimethyl;

bis(9-fluorenyl)(methyl)(vinyl)silane titanium dimethyl;

bis(9-fluorenyl)(methyl)(prop-2-enyl)silane titanium dimethyl;

bis(9-fluorenyl)(methyl)(but-3-enyl)silane titanium dimethyl;

bis(9-fluorenyl)(methyl)(hex-5-enyl)silane titanium dimethyl;

bis(9-fluorenyl)(methyl)(oct-7-enyl)silane titanium dimethyl;

(cyclopentadienyl)(1-allylindenyl) titanium dimethyl;

bis(1-allylindenyl)titanium dimethyl;

(9-(prop-2-enyl)fluorenyl)(cyclopentadienyl)hafnium dimethyl;

(9-(prop-2-enyl)fluorenyl)(pentamethylcyclopentadienyl)hafnium dimethyl;

bis(9-(prop-2-enyl)fluorenyl)hafnium dimethyl;

(9-(cyclopent-2-enyl)fluorenyl)(cyclopentadienyl)hafnium dimethyl;

bis(9-(cyclopent-2-enyl)(fluorenyl)hafnium dimethyl;

5-(2-methylcyclopentadienyl)-5(9-fluorenyl)-1-hexene hafnium dimethyl;

5-(fluorenyl)-5-(cyclopentadienyl)-1-octene hafnium dimethyl;

(9-fluorenyl)(1-allylindenyl)dimethylsilane hafnium dimethyl;

(tert-butylamido)dimethyl(tetramethylcyclopentadienyl)silane titanium(1,3-pentadiene);

(cyclopentadienyl)(9-fluorenyl)diphenylmethane zirconium dimethyl;

(cyclopentadienyl)(9-fluorenyl)diphenylmethane hafnium dimethyl;

dimethylsilanylene-bis(indenyl)thorium dimethyl;

dimethylsilanylene-bis(4,7-dimethyl-1-indenyl)zirconium dimethyl;

dimethylsilanylene-bis(indenyl)uranium dimethyl;

dimethylsilanylene-bis(2-methyl-4-ethyl-1-indenyl)zirconium dimethyl;

dimethylsilanylene-bis(2-methyl-4,5,6,7-tetrahydro-1-indenyl)zirconium dimethyl;

(tert-butylamido)dimethyl(tetramethyl-η⁵-cyclopentadienyl)silane titanium dimethyl;

(tert-butylamido)dimethyl(tetramethyl-η⁵-cyclopentadienyl)silane chromium dimethyl;

(tert-butylamido)dimethyl(tetramethyl-η⁵-cyclopentadienyl)silane titanium dimethyl;

(phenylphosphido)dimethyl(tetramethyl-η⁵-cyclopentadienyl)silane titanium dimethyl; and

[dimethylsilanediylbis(indenyl)]scandium methyl.

In many cases the metallocenes such as referred to above will exist as racemic mixtures, but pure enantiomeric forms or mixtures enriched in a given enantiomeric form can be used.

A feature of this invention is that not all metallocenes can produce compositions having the excellent catalytic activity possessed by the compositions of this invention. For example, in the absence of a separate metal alkyl compound, bis(cyclopentadienyl)dichlorides of Zr cannot produce the compositions of this invention because the chloride atoms are not capable of serving as leaving groups under the conditions used in forming the compositions of this invention. Thus on the basis of the state of present knowledge, in order to practice this invention, it is desirable to perform preliminary tests with any given previously untested metallocene to determine catalytic activity of the product of reaction with a hydroxyaluminoxane. In conducting such preliminary tests, use of the procedures and reaction conditions of the Examples presented hereinafter, or suitable adaptations thereof, is recommended.

In another embodiment of this invention, contrary to that which was previously known, it now surprisingly has been found that rac-ethylene bis(1-indenyl)zirconium dimethyl also can be used to produce a polymerization catalyst composition of this invention which exhibits catalytic activity. Example 15 hereinafter illustrates the preparation and use of this catalyst composition as an olefin polymerization catalyst.

Reaction Conditions

To produce the catalytically active catalyst compositions of this invention the reactants, the d- or f-block metal compound, and the hydroxyaluminoxane that has either been freshly prepared or stored at low temperature (e.g., −10° C. or below) are brought together preferably in solution form or on a support. The reaction between the hydroxy group and the bond between the leaving group and the d- or f-block metal is stoichiometric and thus the proportions used should be approximately equimolar. The temperature of the reaction mixture is kept in the range of −78 to 160° C. and preferably in the range of 15 to 30° C. The reaction is conducted under an inert atmosphere and in an inert environment such as in an anhydrous solvent medium. Reaction times are short, typically within four hours. When the catalyst composition is to be in supported form on a catalyst support or carrier, the suitably dried, essentially hydrate-free support can be included in the reaction mixture. However, it is possible to add the catalyst to the support after the catalyst composition has been formed.

When substituting for the hydroxyaluminoxane reactant in these reactions, a composition according to the second aspect of this invention in the form of one or more individual solids formed from a hydroxyaluminoxane and a carrier material, the reaction conditions for producing the active catalyst compositions will be the same as those taught in the preceding paragraph, with the additional note that use of such composition suspended in a viscous inert liquid (e.g., mineral oil) as previously discussed herein may be preferred in certain applications as the source of the hydroxyaluminoxane reactant. The presence of such viscous inert liquid can act to insulate the resulting activated catalyst composition from air or other reactants in the surrounding environment, and can otherwise facilitate handling of the catalyst compositions. The use of the co-catalyst compositions of matter on carrier material in forming the active catalyst composition are preferred over unsupported hydroxyaluminoxane, since it provides a more stable reactant (the hydroxyaluminoxane/carrier composition) in terms of OH-decay as compared to unsupported hydroxyaluminoxane, which in turn enables the use of lower amounts (on a molar basis) of the hydroxyaluminoxane/carrier composition to obtain at least the same level of activation.

It should also be noted that, in the second aspect of this invention, just as in the formation of the co-catalyst compositions from hydroxyaluminoxane and a carrier material in the second aspect of this invention, catalysts may be formed by bringing together the metal compound and a co-catalyst composition without isolating the co-catalyst from solution. Thus, for example, the metal compound maybe mixed with the co-catalyst composition in the same reaction vessel or zone in which the co-catalyst composition is formed, and whether the co-catalyst is formed by bringing together a starting hydroxyaluminoxane and a carrier material, or by bringing together a starting aluminum alkyl, a carrier material in an inert solvent, and water under co-catalyst forming conditions. In other words, the metal compound may be brought together with a mixture in which the co-catalyst may be formed in order to form the activated catalyst composition in situ, whereupon the catalyst composition may be isolated and used or stored for later use as a polymerization catalyst. The reaction conditions for in situ formation of the active catalyst compositions should be the same as those taught above generally for the formation of the active catalyst compositions. Accordingly, another embodiment of the second aspect of this invention is the process which comprises bringing together, in an inert solvent, an aluminum alkyl and a carrier material to form a first mixture, bringing together the first mixture and a water source to form a second mixture in which a supported hydroxyaluminoxane is formed, and then bringing the second mixture together with the d- or f-block metal compound to form a third mixture in which an activated polymerization catalyst on support is formed. If desired, the activated catalyst then may be isolated from the third mixture. This embodiment presents a particularly economical way of producing the desired catalyst in a supported and highly stable form.

Recovery of the Active Catalyst Compositions

Typically the active catalyst composition can be recovered from the reaction mixture in which it was formed simply by use of a known physical separation procedure. Since the reaction involved in the formation of the product preferably uses a metallocene having one or two methyl groups whereby gaseous methane is formed as the coproduct, the metal-containing catalyst product is usually in a reaction mixture composed almost entirely of the desired catalyst composition and the solvent used. This renders the recovery procedure quite facile. For example, where the product is in solution in the reaction mixture, the solvent can be removed by stripping off the solvent under reduced pressure and at moderately elevated temperature. Often the residual product recovered in this manner is of sufficient purity that further purification is not required. In the event the product is in the form of solids which precipitate from the solvent, or which are caused to precipitate from the solution by the addition of a suitable non-solvent, physical solid-liquid separation procedures such as filtration, centrifugation, and/or decantation can be employed. The product recovered in this manner is usually of sufficient purity that further purification is not required. Whatever the method of recovery used, if further purification is needed or desired, conventional purification steps, such as crystallization can be used.

The product need not be recovered or isolated directly from the liquid reaction medium in which it was prepared. Instead, it can be transferred to another solvent, for example, by use of a solvent extraction procedure or a solvent swap procedure whereby the product is removed from the liquid phase in which it was produced and is thus dissolved in a different solvent. Although unnecessary, this new solution can be subjected to still another solvent extraction, or solvent swap, as many times as desired, recognizing of course that the longer the product remains in solution the greater the opportunity for product degradation to occur. In any case referred to in this paragraph, the catalytically active product is recovered or isolated from a solution other than the liquid phase in which it was produced, and is maintained in undissolved condition under dry, anhydrous conditions.

Storage of Recovered Active Catalyst Compositions

The recovered catalyst compositions of this invention can be stored in any suitable air-tight container either under vacuum or under an atmosphere of anhydrous inert gas, such as nitrogen, helium, argon, or the like. To protect against possible light-induced degradation, the container is preferably opaque or rendered opaque toward light transmission and/or the package containing the catalyst composition is kept in a suitable dark storage area. Likewise it is desirable to store the product in locations that will not become excessively hot. Exposure to storage temperatures of up to 30° C. typically will cause no material loss in activity, but naturally the effect of temperatures likely to be encountered during storage should be determined for any given catalyst where such information has not previously been ascertained.

The length of time during which the recovered active catalyst composition is stored can be as short as a minute or less. For example, the active catalyst composition could be produced in an appropriate amount at the site of the polymerization and immediately upon isolation could be directly transferred to the polymerization reaction vessel. The storage period in such case could be very short, namely the time between isolation of the active catalyst composition and commencement of its use as the catalyst in the polymerization. On the other hand, the storage period can be substantially longer provided that the storage occurs under the appropriate conditions at all times during the storage. For example, the active catalyst composition could be produced, placed in a suitable air-tight, moisture-resistant vessel or container under a dry, anhydrous atmosphere promptly after its isolation, and then maintained in inventory in a suitable air-tight, moisture-resistant vessel or container under a dry, anhydrous atmosphere, all at the site of its manufacture, and with these steps being conducted such that the amount of exposure to air or moisture, if any, is kept at all times to such a minimal amount as not to adversely affect the activity of the catalyst composition. All or a portion of such stored active catalyst composition could then be shipped under these same conditions to another site, typically the site where its use as a polymerization catalyst is to take place. And after reaching the site where the composition is to be used as a catalyst, the composition could then again be kept in inventory under the same or substantially the same type of suitable storage conditions at that site until portions of the catalyst composition are put to use as a catalyst. In such a case the overall storage period could be very long, e.g., as long as the particular catalyst composition retains suitable catalytic activity. Thus the period of storage is discretionary and is subject to no numerical limitation as it can depend on such factors as the extent of care exercised in the various steps to which the stored product is subjected during storage, the conditions existing or occurring during the storage, and so on. Thus as a practical matter the period of time of the storage can be the period of time during which the catalyst does not lose its activity or effectiveness when used as a polymerization catalyst.

The catalyst compositions of this invention can be stored in isolated form, or in various other undissolved forms. For example, after recovery, the active catalyst composition can be mixed under dry, anhydrous conditions with dry inert materials such as calcined particulate or powdery silica, alumina, silica-alumina, clay, montmorillonite, diatomaceous earth, or like substance, and the resultant dry blend can be stored under appropriate dry, anhydrous conditions. Similarly, after recovery, the active catalyst composition can be mixed under dry, anhydrous conditions with other kinds of dry inert materials such as chopped glass fibers, glass beads, carbon fibers, metal whiskers, metal powders, and/or other materials commonly used as reinforcing fillers for polymers, and the resultant blends can then be stored under appropriate dry, anhydrous conditions. In a preferred embodiment, after recovery, the active catalyst composition is supported on a dry catalyst support material such as calcined silica, calcined silica-alumina, calcined alumina, particulate polyethylene, particulate polypropylene, or other polyolefin homopolymer or copolymer under anhydrous air-free conditions using known technology, and the resultant supported catalyst composition is then stored under appropriate dry, anhydrous conditions. In case anyone needs to be told what “appropriate conditions” are, they include not exposing the stored catalyst composition to such high temperatures as would cause destruction of the catalyst or its catalytic activity, and not exposing the stored catalyst to light wave energy or other forms of radiation of such type or magnitude as would cause destruction of the catalyst or its catalytic activity. Here again, this disclosure as any patent disclosure, should be read with at least a little common sense, rather than with legalistic word play in mind.

The catalyst compositions of this invention are particularly stable, as they typically will be able to be maintained in a dry state under anhydrous or substantially anhydrous conditions and at a temperature in the range of 5 to 70° C., more preferably in the range of 10 to 60° C., and most preferably in the range of 15 to 35° C., for a period of time of at least 24 hours, more preferably for at least 48 hours, and most preferably at least 72 hours, without losing fifty percent (50%) or more of its catalytic activity. It should be appreciated that such catalytic activity would be measured in terms of grams of polymer per gram of catalyst composition per hour, samples being compared using identical polymerization reaction conditions.

Polymerization Processes Using Catalysts of this Invention

The catalyst compositions of this invention can be used in solution or deposited on a solid support. Depositing upon a carrier or solid support is particularly preferred. When used in solution polymerization, the solvent can be, where applicable, a large excess quantity of the liquid olefinic monomer. Typically, however, an ancillary inert solvent, typically a liquid paraffinic or aromatic hydrocarbon solvent is used, such as heptane, isooctane, decane, toluene, xylene, ethylbenzene, mesitylene, or mixtures of liquid paraffinic hydrocarbons and/or liquid aromatic hydrocarbons. When the catalyst compositions of this invention are supported on a carrier, the solid support or carrier can be any suitable particulate solid, and particularly a porous support such as talc, zeolites, or inorganic oxides, or resinous support material such as polyolefins. Preferably, the support material is an inorganic oxide in finely divided form.

Suitable inorganic oxide support materials which are desirably employed include metal oxides such as silica, alumina, silica-alumina and mixtures thereof. Other inorganic oxides that may be employed either alone or in combination with the silica, alumina or silica-alumina are magnesia, titania, zirconia, and like metal oxides. Other suitable support materials are finely divided polyolefins such as finely divided polyethylene.

Polymers can be produced pursuant to this invention by homopolymerization of polymerizable olefins, typically 1-olefins (also known as α-olefins) such as ethylene, propylene, 1-butene, or copolymerization of two or more copolymerizable monomers, at least one of which is typically a 1-olefin. The other monomer(s) used in forming such copolymers can be one or more different 1-olefins and/or a diolefin, and/or a polymerizable acetylenic monomer. Olefins that can be polymerized in the presence of the catalysts of this invention include α-olefins having 2 to 20 carbon atoms such as ethylene, propylene, 1-butene, 1-hexene, 4-methyl-1-pentene, 1-octene, 1-decene, 1-dodecene, 1-tetradecene, 1-hexadecene, and 1-octadecene. Other suitable monomers for producing homopolymers and copolymers include styrenic monomers, e.g., styrene, ar-methylstyrenes, alpha-methylstyrene, ar-dimethylstyrenes, ar-ethylstyrene, 4-tert-butylstyrene, and vinylnaphthalene. Still other suitable monomers include polycyclic monomers. Illustrative examples of suitable polycyclic monomers include 2-norbornene, 5-methyl-2-norbornene, 5-hexyl-2-norbornene, 5-decyl-2-norbornene, 5-phenyl-2-norbornene, 5-naphthyl-2-norbornene, 5-ethylidene-2-norbornene, vinylnorbornene, dicyclopentadiene, dihydrodicyclopentadiene, tetracyclododecene, methyltetracyclododecene, tetracyclododecadiene, dimethyltetracyclododecene, ethyltetracyclododecene, ethylidenyl tetracyclododecene, phenyltetracyclododecene, trimers of cyclopentadiene (e.g., symmetrical and asymmetrical trimers). Copolymers based on use of isobutylene as one of the monomers can also be prepared. Normally, the hydrocarbon monomers used, such as 1-olefins, diolefins and/or acetylene monomers, will contain up to 10 carbon atoms per molecule. Preferred 1-olefin monomers for use in the process include ethylene, propylene, 1-butene, 3-methyl-1-butene, 4-methyl-1-pentene, 1-hexene, and 1-octene. It is particularly preferred to use supported or unsupported catalysts of this invention in the polymerization of ethylene, or propylene, or ethylene and at least one C₃-C₈ 1-olefin copolymerizable with ethylene. Typical diolefin monomers which can be used to form terpolymers with ethylene and propylene include butadiene, hexadiene, norbornadiene, and similar copolymerizable diene hydrocarbons. 1-Heptyne and 1-octyne are illustrative of suitable acetylenic monomers which can be used.

Polymerization of ethylene or copolymerization with ethylene and an α-olefin having 3 to 10 carbon atoms may be performed in either the gas or liquid phase (e.g. in a diluent, such as toluene, or heptane). The polymerization can be conducted at conventional temperatures (e.g., 0° to 120° C.) and pressures (e.g., ambient to 50 kg/cm²) using conventional procedures as to molecular weight regulations and the like.

The heterogeneous catalysts of this invention can be used in polymerizations conducted as slurry processes or as gas phase processes. By “slurry” is meant that the particulate catalyst is used as a slurry or dispersion in a suitable liquid reaction medium which may be composed of one or more ancillary solvents (e.g., liquid aromatic hydrocarbons) or an excess amount of liquid monomer to be polymerized in bulk. Generally speaking, these polymerizations are conducted at one or more temperatures in the range of 0 to 160° C., and under atmospheric, subatmospheric, or superatmospheric conditions. Conventional polymerization adjuvants, such as hydrogen, may be employed if desired. Preferably polymerizations conducted in a liquid reaction medium containing a slurry or dispersion of a catalyst of this invention are conducted at temperatures in the range of 40 to 110° C. Typical liquid diluents for such processes include hexane, toluene, and like materials. Typically, when conducting gas phase polymerizations, superatmospheric pressures are used, and the reactions are conducted at temperatures in the range of 50 to 160° C. These gas phase polymerizations can be performed in a stirred or fluidized bed of catalyst in a pressure vessel adapted to permit the separation of product particles from unreacted gases. Thermostated ethylene, comonomer, hydrogen and an inert diluent gas such as nitrogen can be introduced or recirculated to maintain the particles at the desired polymerization reaction temperature. An aluminum alkyl such as triethylaluminum may be added as a scavenger of water, oxygen and other impurities. In such cases the aluminum alkyl is preferably employed as a solution in a suitable dry liquid hydrocarbon solvent such as toluene or xylene. Concentrations of such solutions in the range of 5×10⁻⁵ molar are conveniently used. But solutions of greater or lesser concentrations can be used, if desired. Polymer product can be withdrawn continuously or semi-continuously at a rate that maintains a constant product inventory in the reactor.

The catalyst compositions of this invention can also be used along with small amounts of hydrocarbylborane compounds such as triethylborane, tripropylborane, tributylborane, tri-sec-butylborane. When so used, molar Al/B ratios in the range of 1/1 to 1/500 can be used.

Because of the high activity and productivity of the catalysts of this invention, the catalyst levels used in olefin polymerizations can be less than previously used in typical olefin polymerizations conducted on an equivalent scale. In general, the polymerizations and copolymerizations conducted pursuant to this invention are carried out using a catalytically effective amount of a novel catalyst composition of this invention, which amount may be varied depending upon such factors such as the type of polymerization being conducted, the polymerization conditions being used, and the type of reaction equipment in which the polymerization is being conducted. In many cases, the amount of the catalyst of this invention used will be such as to provide in the range of 0.000001 to 0.01 percent by weight of d- or f-block metal based on the weight of the monomer(s) being polymerized.

After polymerization and deactivation of the catalyst in a conventional manner, the product polymer can be recovered from the polymerization reactor by any suitable means. When conducting the process with a slurry or dispersion of the catalyst in a liquid medium the product typically is recovered by a physical separation technique (e.g. decantation). The recovered polymer is usually washed with one or more suitably volatile solvents to remove residual polymerization solvent or other impurities, and then dried, typically under reduced pressure with or without addition of heat. When conducting the process as a gas phase polymerization, the product after removal from the gas phase reactor is typically freed of residual monomer by means of a nitrogen purge, and often can be used without further catalyst deactivation or catalyst removal.

When preparing polymers pursuant to this invention conditions may be used for preparing unimodal or multimodal polymer types. For example, mixtures of catalysts of this invention formed from two or more different metallocenes having different propagation and termination rate constants for ethylene polymerizations can be used in preparing polymers having broad molecular weight distributions of the multimodal type.

Third Aspect

Hydroxyaluminoxane Reactants

For the third aspect of this invention, the hydroxyaluminoxane reactants generally are as previous described above for the first aspect (or described above without reference to the second aspect), with the following additional description being applicable to this third aspect of the invention.

It now has been discovered that the rate of OH-decay (i.e., the rate at which OH groups disassociate so as to reduce the number of OH groups present in the molecule) of the above-described hydroxyalumioxane may be drastically and surprisingly reduced by converting hydroxyaluminoxane in an inert solvent into a gelatinous composition of matter, or into a solid composition of matter formed from said gelatinous composition of matter, or into a mixture of said solid and said gelatinous composition, whereby the rate of OH-decay for the gelatinous composition, the solid composition, or the mixture is reduced as compared to the rate of OH-decay for the hydroxyaluminoxane. The inert solvent which forms solution with the hydroxyaluminoxane should be inert to the other materials involved and is typically a liquid paraffinic or aromatic hydrocarbon solvent such as, e.g., heptane, isooctane, decane, toluene, xylene, ethylbenzene, mesitylene, or mixtures of liquid paraffinic hydrocarbons and/or liquid aromatic hydrocarbons. The amount of inert solvent present can vary widely, but typically will be at least enough to dissolve the hydroxyaluminoxane. The gelatinous composition of this third aspect of the invention is formed by bringing together the hydroxyaluminoxane in an inert solvent and a treating agent which is compatible with the hydroxyaluminoxane. The solid composition may be formed by removal of the inert solvent from the gelantinous composition by, for example, solvent stripping. This solid composition of matter may also serve as a co-catalyst component in forming the olefin polymerization catalyst. Without being bound to theory, both the gelatinous and the solid co-catalyst compositions of matter appear to remain active as a Brønsted acid for a surprisingly greater period of time as compared to that of the hydroxyaluminoxane.

For purposes of the third aspect of this invention, when it is stated herein that the treating agent is considered “compatible” with the hydroxyaluminoxane, it is meant that the treating agent is capable of coming into proximity or contact with, or being mixed with or otherwise placed in the presence of, the hydroxyaluminoxane without adversely affecting the ability of the hydroxyaluminoxane to activate the metal compound elsewhere described herein to form the polymerization catalysts of this invention.

Typically, the rate of OH-decay for the composition so formed is reduced by a factor of at least 5, and more preferably at least 10, as compared to the rate of OH-decay of the hydroxyaluminoxane. The gelatinous composition formed by bringing together at least the hydroxylaluminoxane in an inert solvent and the treating agent may be used to form active polymerization catalysts of this invention.

The treating agent employed to form the co-catalysts of the third aspect of this invention is preferably free water, but may alternatively be a hydrate of alkali or alkaline earth metal hydroxides such as, for example, lithium, sodium, potassium, barium, calcium, magnesium, and cesium hydroxides (e.g., sodium hydroxide mono- and dihydrate, barium hydroxide octahydrate, potassium hydroxide dihydrate, cesium hydroxide monohydrate, lithium hydroxide monohydrate, and the like), aluminum sulfate, as well as mixtures of any two or more of the foregoing.

One preferred method of converting the hydroxyaluminoxane in an inert solvent into a gelatinous composition of matter is mixing the hydroxyaluminoxane in an inert solvent with a gel-forming amount of the treating agent. The amount of treating agent necessary to be gel-forming will vary, depending upon the hydroxyaluminoxane involved. The amount of treating agent employed must at least be sufficient to cause the gelatinous composition to form. When the hydroxyaluminoxane is hydroxyisobutylaluminoxane and the treating agent is free water, for example, the amount of water is preferably sufficient to provide a water to aluminum molar ratio which exceeds 1.10.

The treating agent of this third aspect of the invention may be brought together with the hydroxyaluminoxane in an inert solvent by any number of ways such as mixing, contacting or co-feeding, employing any sequence of addition. Preferably, the treating agent will be added slowly (e.g., dropwise) to the hydroxyaluminoxane and solvent solution. It is also preferably that the treating agent and hydroxyaluminoxane in solvent be brought together at relatively low temperature (i.e., at or below 10° C.) and under an inert atmosphere such as, e.g., nitrogen. The reaction conditions are not pressure dependent, as atmospheric, subatmospheric and superatmospheric pressure may be employed, with the pressure conditions preferably being selected to avoid hindering formation of the gelatinous composition.

Again with respect to the third aspect of this invention, for quantitative purposes with respect to the number of hydroxyl groups present in the hydroxyaluminoxane or in the composition made therefrom, typically samples will be stored at room temperature in a dry box and sampled periodically for quantitative analysis to determine the rate of OH-decay at given points in time. A typical procedure with respect to hydroxyisobutylaluminoxane gel may employ FT-IR spectra as described below in the paragraph immediately preceding Example 21. This procedure will preferably be employed to quantify the hydroxyl groups (as HO— per 100 aluminum atoms) present in the composition at or near the time of fresh preparation (i.e., time zero), and at one or more intervals of time thereafter, preferably at 48 hours or more preferably at 72 hours following preparation of the sample materials. The change in the number of hydroxyl groups at the selected time interval from that at time zero, divided by the amount of time, will be the OH-decay rate.

These co-catalyst compositions formed from the hydroxyaluminoxane in inert solvent and the treating agent maybe formed and isolated (e.g., by solidifying through solvent stripping) prior to use as a catalyst component, or they may be formed in situ, such as, e.g., during the process of production of the hydroxyaluminoxane itself or even production of the desired activated catalyst. Accordingly, these compositions may be formed by addition of sufficient amounts of the treating agent during the synthesis of hydroxyaluminoxane. For example, the water source employed to form the initial hydroxyaluminoxane may also function as the treating agent when a sufficient amount of the water source is added so as to form the gelatinous composition of matter. Besides free water, other non-limiting examples of a suitable water source include the same examples as given for the treating agent. Free water is preferred. The reaction conditions for this in situ formation of the gelatinous composition of matter will typically be the same as those reactions conditions taught herein for forming the hydroxyaluminoxane generally. Once the gelatinous composition is formed, or the solid composition derived from the gelatinous composition, or a mixture of both, is formed, the composition or mixture may be brought together (e.g., by mixing, contacting, co-feeding) with a d- or f-Block metal compound described hereinafter, using reaction conditions as hereinafter described so as to form the activated olefin polymerization catalyst in a single pot process.

When forming the co-catalyst composition from the hydroxyaluminoxane in inert solvent and the treating agent, it is preferred that the hydroxyaluminoxane have less than 25 OH groups per 100 aluminum atoms, and even more preferred that the hydroxyaluminoxane have no more than 15 OH groups per 100 aluminum atoms. In certain other embodiments of this invention, it is also preferred that the composition so made be substantially insoluble in an inert organic solvent such as various liquid hydrocarbons, e.g., liquid saturated aliphatic or cycloaliphatic hydrocarbons. Hydroxyisobutylaluminoxane is particularly preferred as the hydroxyaluminoxane.

These compositions formed from a hydroxyaluminoxane and a treating agent may be employed as the olefin polymerization co-catalyst in place of the less stable hydroxyaluminoxane, to provide a surprisingly more stable yet equally effective co-catalyst and/or catalyst composition which features substantially reduction if not elimination, of reactor fouling.

d- or f-Block Metal Compound

For the third aspect of this invention, the d- or f-block metal compound is as previous described for the first and second aspects of this invention.

Reaction Conditions

For the third aspect of this invention, the reaction conditions are as previous described above for the first aspect of this invention (without reference to the second aspect of this invention), with the following additional information being applicable to the third aspect of this invention.

When substituting for the hydroxyaluminoxane reactant in these reactions the composition of matter of the third aspect of this invention which is in the form of either a gelatinous composition or a solid composition formed from the gelatinous composition, or a mixture of both, the reaction conditions for producing the active catalyst compositions will be the same as those taught in the preceding paragraph. The use of these co-catalyst compositions of matter in forming the active catalyst composition are preferred over unsupported hydroxyaluminoxane, since they provide a more stable reactant (the hydroxyaluminoxane gel and/or gel-derived solid compositions) in terms of OH-decay as compared to unsupported hydroxyaluminoxane, which in turn enables the use of lower amounts (on a molar basis) of the hydroxyaluminoxane gel and/or gel-derived solid composition to obtain at least the same level of activation.

With respect to the third aspect of this invention, it should also be noted that, just as in the formation of the co-catalyst compositions from hydroxyaluminoxane and a treating agent, the catalysts may be formed by bringing together the metal compound and the co-catalyst composition without isolating the co-catalyst from solution. Thus, for example, the metal compound may be mixed with the co-catalyst composition in the same reaction vessel or zone in which the co-catalyst composition is formed, and whether the co-catalyst is formed by bringing together a starting hydroxyaluminoxane and a treating agent, or by bringing together a starting aluminum alkyl and water source (e.g., water) under gelatinous co-catalyst composition forming conditions. In other words, the metal compound may be brought together with a mixture in which the co-catalyst may be formed in order to form the activated catalyst composition in situ, whereupon the catalyst composition may be isolated and used or stored for later use as a polymerization catalyst. The reaction conditions for in situ formation of the active catalyst compositions should be the same as those taught above generally for the formation of the active catalyst compositions. Accordingly, another embodiment of this invention is the process which comprises bringing together, in an inert solvent, an aluminum alkyl and a water source to form a first mixture in which a gelatinous composition is formed, and then bringing the first mixture together with the d- or f-block metal compound to form a second mixture in which an activated polymerization catalyst is formed. If desired, the activated catalyst then may be isolated from the second mixture. This embodiment presents a particularly economical way of producing the desired catalyst in a highly stable form.

Recovery of the Active Catalyst Compositions

In the third aspect of this invention, the recovery of the active catalyst compositions is as previous described for the first and second aspects of this invention.

Storage of Recovered Active Catalyst Compositions

In the third aspect of this invention, the storage of recovered active catalyst compositions is as previous described for the first and second aspects of this invention.

Polymerization Processes Using Catalysts of this Invention

In the third aspect of this invention, the polymerization processes using catalysts of this invention are as previous described for the first and second aspects of this invention, with the exception that depositing upon a carrier or solid support is not necessarily preferred given the support-activator nature of the gelantinous co-catalyst compositions or solids derived therefrom, or both, employed to form the catalyst.

Experimental Section

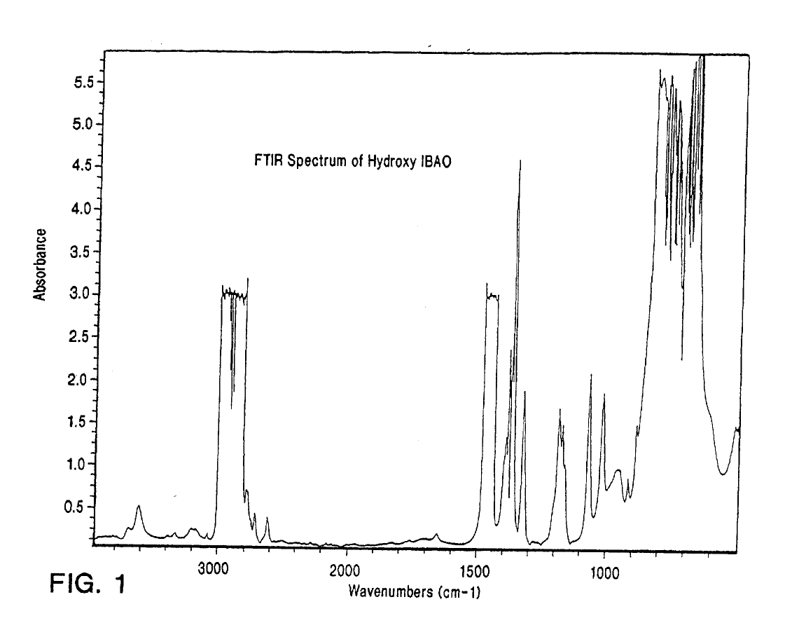

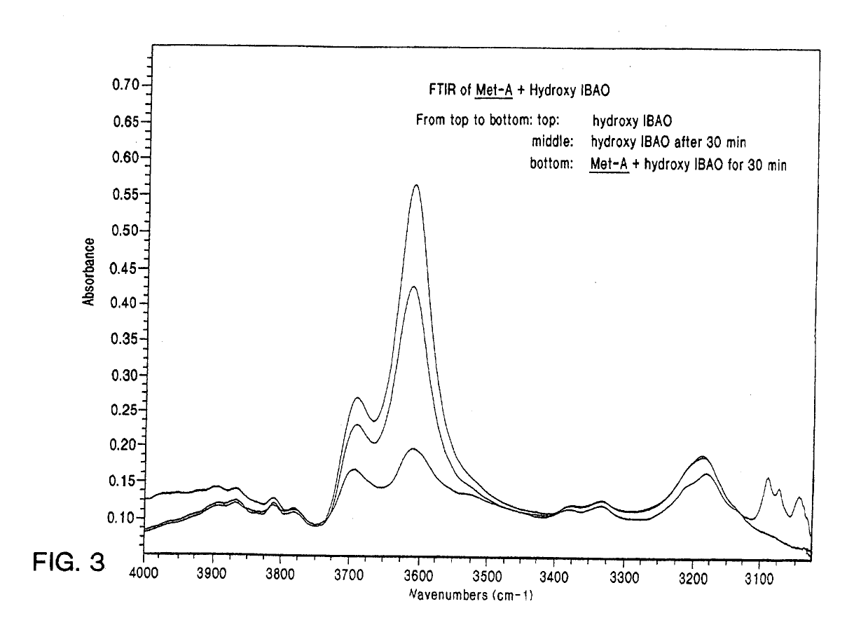

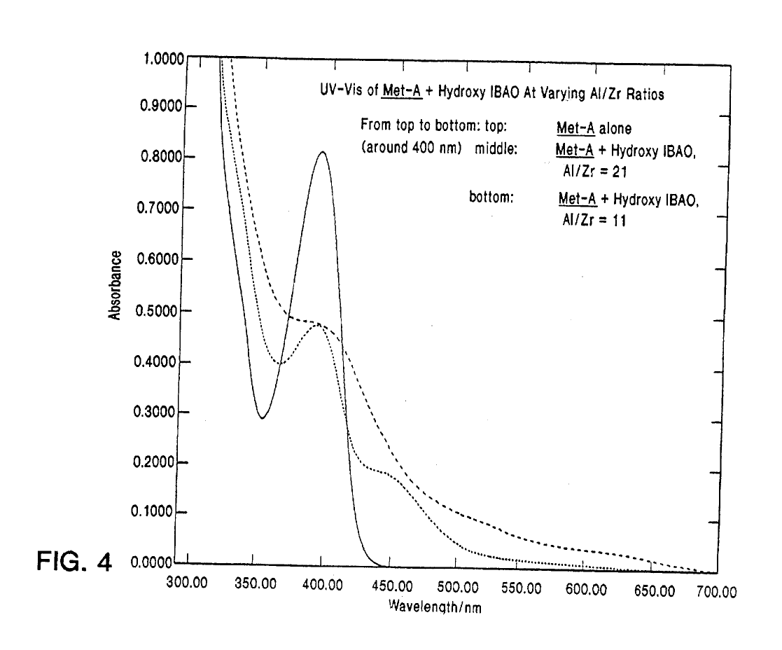

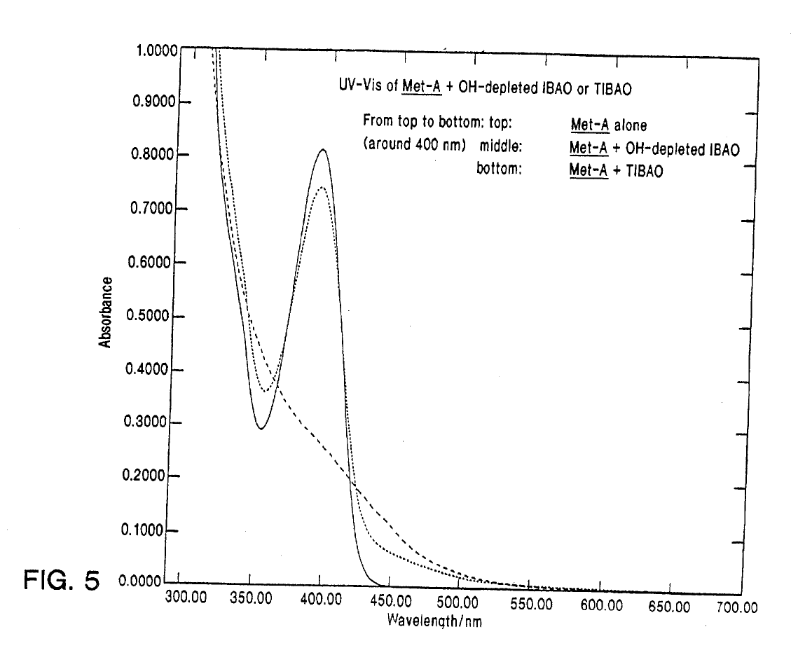

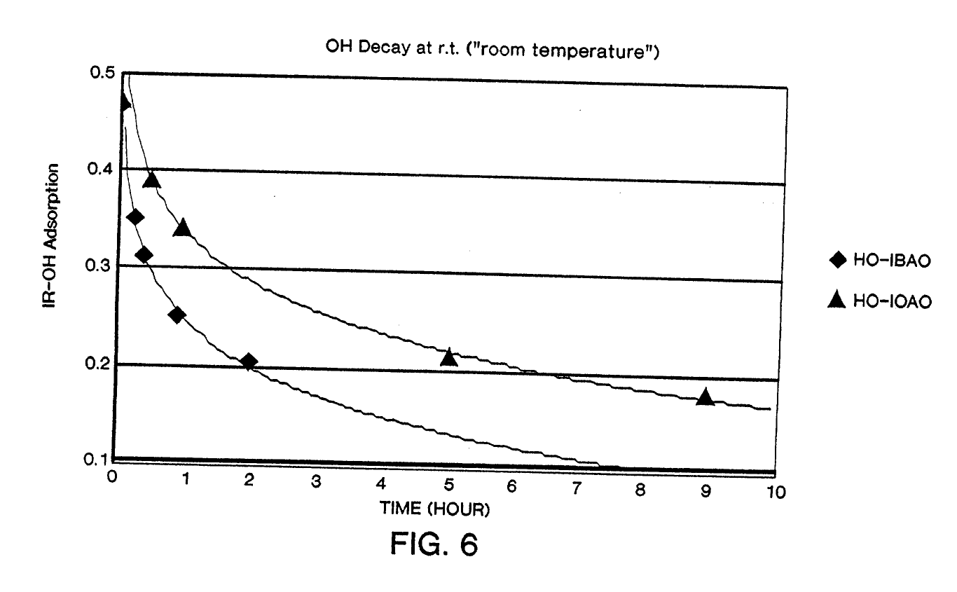

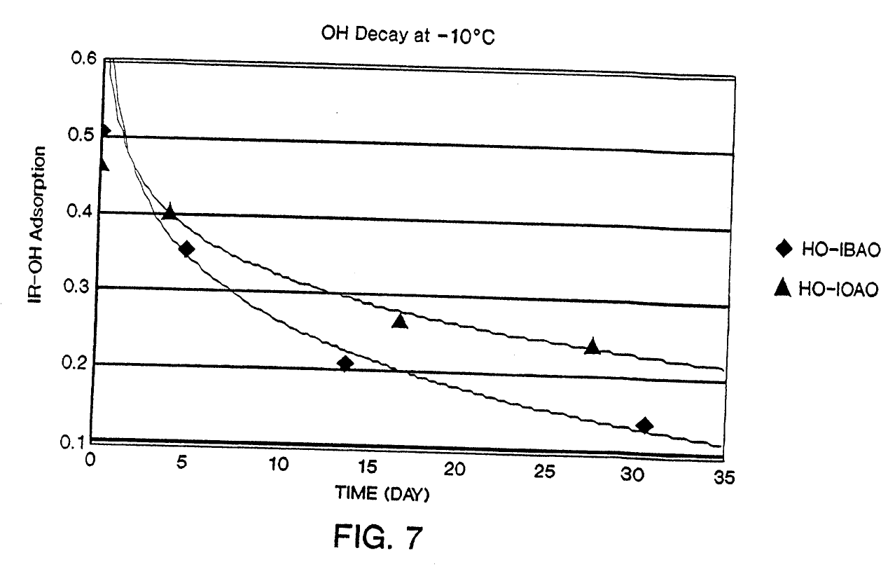

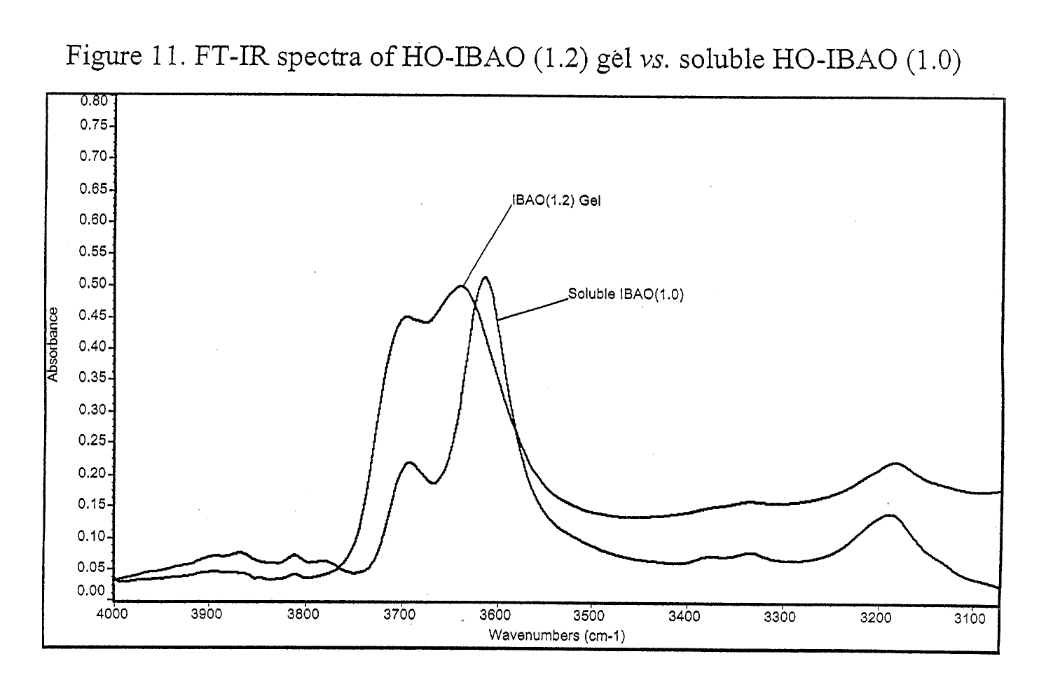

The following Examples are presented for purposes of illustration and not limitation. All operations of these Examples were carried out under nitrogen either in a drybox with below 1 ppm oxygen or using standard Schlenk line techniques. Methylaluminoxane (MAO), triisobutylaluminum (TIBA), triethylaluminum (TEA), were commercial products of Albemarle Corporation and used as received. Reagents benzylmagnesium chloride and MeLi with LiBr were purchased from Aldrich and used as received. Toluene, ethylene, propylene, and nitrogen used in the polymerization reactions were purified by passing through a series of three cylinders: molecular sieves, Oxyclear oxygen absorbent, and alumina. Ethylene and propylene were polymer grade from Matheson. Toluene for catalyst preparation and spectroscopy studies was Aldrich anhydrous grade and was distilled from sodium/benzophenone ketyl. Hexane was Aldrich anhydrous grade and stored over Na/K alloy. The metallocenes used in these Examples were prepared according to procedures given in the literature. Thus Cp₂ZrMe₂ was prepared using the method of Samuel, et al., J. Am. Chem. Soc., 1973, 95, 6263; rac-dimethylsilylbis(2-methyl-1-indenyl)zirconium dichloride using the method of Spaleck, et al., Angew. Chem., Int. Ed. Engl., 1992, 31, 1347, and Winter, et al. U.S. Pat. No. 5,145,819; and bis(1-methyl-3-n-butyl-cyclopentadienyl)zirconium dichloride using the method of Lee, et al., Canadian Pat. No. 2,164,914, July 1996. The FT-infrared spectra of FIGS. 1, 2 and 3 were recorded on a Nicolet Magna-IR 750 spectrometer with 32 scans and 2 cm⁻¹ resolution using 0.5 mm NaCl cells, while that the FT-IR spectra in FIG. 11 were recorded by a Nicolet Magna 560 FTIR bench with a Nic-Plan infrared microscope using 64 scans and 8 cm⁻¹ resolution. The absorption of hexane was compensated by subtraction with a reference hexane spectrum acquired from the same cell. The UV-Vis spectra were recorded in the 290-700 nm region on a Varian Cary 3E spectrometer. Quartz cuvettes of 1 cm pathlength were used. Diffuse reflectance infrared Fourier transform spectroscopy (DRIFTS) used a Nicolet Magna 750 FTIR bench equipped with a “Collector” diffuse reflectance accessory from Spectra-Tech with a high temperature/high pressure sample chamber. The DRIFTS spectra were obtained at 4 cm⁻¹ resolution and 128 scans. The molecular weight and molecular weight distribution were determined by gel permeation chromatography which incorporated three different modes of detection including differential refractive index (Polymer Labs), laser light scattering (Precision Detectors) and differential pressure viscometry (Viscotek Corporation). The chromatographic instrument was a Polymer Labs 210 using 1,2,4-trichlorobenzene as the eluting solvent at 150° C. A series of linear mixed bed GPC columns were used to perform the separation and the data was collected and analyzed using Viscotek's TriSEC software package. The samples were dissolved in the trichlorobenzene for 2-4 hours at 150° C.-at a concentration of approximately 2000 rpm. MFI, melt flow index, was determined by the ASTM D1238 method.

In U.S. Pat. No. 6,160,145, Example 1, the preparation of rac-dimethylsilylbis-(2-methylindenyl)zirconium dimethyl (MET-A) is described.

In U.S. Pat. No. 6,160,145, Example 2, the preparation of bis(1-butyl-3-methylcyclopentadienyl)zirconium dimethyl (MET-B) is described.

In U.S. Pat. No. 6,160,145, Example 3, a synthesis of hydroxyisobutylaluminoxane (HO-IBAO) is described.

In U.S. Pat. No. 6,160,145, Example 4, a synthesis of deuteroxyisobutylaluminoxane (DO-IBAO) is described.

In U.S. Pat. No. 6,160,145, Example 5, a characterization of HO-IBAO by IR-spectroscopy is described.

In U.S. Pat. No. 6,160,145, Example 6, a quantification of hydroxy content in HO-IBAO (benzyl Grignard method) is described.

In U.S. Pat. No. 6,160,145, a verification of novel metallocene activation mechanism (HO-IBAO functioning as a Brønsted acid) is described at Examples 7, 8, and 9.

In U.S. Pat. No. 6,160,145, UV-Vis spectra of rac-dimethylsilylbis-(2-methylindenyl) zirconium dimethyl+Hydroxy IBAO with varying Al/Zr ratios is described at Example 10.

The highly advantageous results achievable using the polymerization reactions of the invention of U.S. Pat. No. 6,160,145 are illustrated therein at Examples 11-14 and the Comparative Examples A-G.

### EXAMPLE 15

### Polymerization Using Rac-Ethylene Bis(1-indenyl)zirconium Dimethyl Pre-Catalyst

A 15 mL high pressure mini-reactor was placed in a drybox and equipped with a plastic anchor stirrer rotating at about 500 rpm. Hydroxyisobutylaluminoxane previously was made by hydrolyzing TIBA with one equivalent of water, and at the time of use in this polymerization contained 4-5 OH groups per 100 Aluminum atoms. The metallocene, rac-ethylene bis(1-indenyl)zirconium dimethyl, was slurried in hexane in the mini-reactor at ambient temperature, and the hydroxyisobutylaluminoxane was added thereto. The metallocene quickly dissolved to give a deep red solution. The Al/Zr molar ratio was 30:1. The mini-reactor was then charged with a portion of the catalyst composition (0.2 micromoles Zr) and a 3 wt % TIBA solution in hexane (about 1 micromole Al). The reactor was then scaled and 6 mL of liquid propylene was pressed into the reactor via a syringe pump to start the polymerization. The temperature was quickly brought to 65° C. within four to six minutes. The polymerization was allowed for another 10 minutes at 65° C., during which time all propylene was consumed. After drying, 3.5 g of polypropylene was collected. The C13-nmr of the polymer showed mmmm % equal to 84.5% and isotacticity index of 94.1%.

Examples 16-20 illustrate the preparation, isolation, and storage stability of the isolated catalyst compounds at ambient room temperatures. In these Examples, the stability of the catalyst was monitored by UV-Vis spectroscopy. In this method, it is assumed that the absorbance of the bathochromically shifted metallocenium ion correlates with the catalyst activity; i.e., the higher the absorbance, the more catalytically active the metallocene. This correlation has been verified by Deffieux's research group in three recently published papers: D. Coevoet et al. Macromol. Chem. Phys., 1998, 199, 1451-1457; D. Coevoet et al. Macromol. Chem. Phys., 1998, 199, 1459-1464; and J. N. Pedeutour et al. Macromol. Chem. Phys., 1999, 199, 1215-1221.

In Example 10 of U.S. Pat. No. 6,160,145 to Wu et al., it is shown that the starting metallocene having an LMCT band at 394 nm diminishes upon activation by HO-IBAO. The disappearance is accompanied by the growth of a broad absorption band extended just beyond 700 nm. In Examples 16 et seq., use is made of the absorbance at 600 nm for the purpose of monitoring stability. All UV-Vis samples have a same [Zr] concentration of 0.346 mM (2 μmol Zr in 5 g of toluene) in toluene.

### EXAMPLE 16

### Stability of MET-A+HO-IBAO as an Isolated Product (Al/Zr=200)

To a suspension of dimethylsilylbis(2-methylindenyl)zirconium dimethyl (MET-A) (30 mg, 68 μmmol) in 10 mL hexane was added a solution of hydroxyisobutylaluminoxane (HO-IBAO) (13.2 g, 20 mmol Al) with stirring. Prior to the addition, the solution and the suspension were both cooled to −10° C. and after mixing, the resulting mixture was allowed to return to room temperature. The metallocene gradually dissolved to give a deep red-brown solution. After 45 minutes of stirring, the solution was stripped of volatiles under vacuum to initially give a foamy residue which was broken up by a spatula. Another 2 hours of pumping yielded a completely dry brown powder which weighed 1.4 g. The brown solid was stored in a drybox at room temperature, and was periodically sampled for stability determinations. Each sample was redissolved in toluene, and the stability of the product was monitored by UV-Vis at 600 nm by measuring the metallocenium concentration of the respective redissolved samples. Samples were taken right after the isolated product had been dried, and after the isolated product had been stored for 6 days, 15 days, and 39 days. The results, summarized in Table 1, show that the metallocenium concentration stayed constant throughout at least a 39-day period. After one month of storage, the solid product was shown by a micro calorimetric test system to be highly active in ethylene polymerization (50° C./50 psi in toluene).

TABLE 1
Change of UV-Vis Absorbance at 600 nm with Time

| Storage Time | Product of Example 16 |
|---|---|
| Right after drying | 0.183 |
| 6 Days | 0.181 |
| 15 Days | 0.187 |
| 39 Days | 0.182 |

### EXAMPLE 17

### Stability of MET-A+HO-IBAO Product Dissolved in Toluene

A catalyst solution of Met-A and HO-IBAO with an Al/Zr molar ratio of 100, was prepared. This solution was divided into two solutions, sample A and B, whose UV-Vis spectra upon storage over time were recorded. Sample A was stored at ambient temperature in a drybox at all times. Sample B was stored at ambient temperature for the first 4.5 hours, and after that was stored at −10° C. except during the spectra acquisition which is done at room temperature. The results are summarized in Table 2, in which the values marked with an asterisk are values of samples taken from the product while the product was being stored at −10° C.

TABLE 2
Change of UV-Vis Absorbance at 600 nm with Time

| Storage Time | Sample A | Sample B |
|---|---|---|
| 2 Hours | 0.149 | 0.153 |
| 4.5 Hours | 0.135 | 0.127 |
| 28 Hours | 0.101 | 0.126* |
| 5 Days | 0.081 | 0.124* |
| 12 Days | 0.064 | 0.121* |

The results in Table 2 clearly show that the catalyst is unstable in solution at ambient room temperature but is rather stable in solution at −10° C.

### EXAMPLE 18

### Stability of MET-A+HO-IBAO as an Isolated Product (Al/Zr=50)

To a solution of HO-IBAO in hexane (6.78 g, 10.2 mmol Al) and 6.1 g toluene was added solid MET-A (88 mg, 204 μmol) while the solution was cold. As a consequence of a lower Al/Zr ratio used in this Example, toluene was needed to dissolve the metallocene. After 23 minutes of stirring at room temperature, the resulting dark brown solution was stripped of volatiles in vacuo to give a foamy residue which was broken up by a spatula. After a further 4 hours of pumping, 1.1 g of a brown powder was isolated. The UV-Vis absorbances of this product at 600 nm were 0.116 and 0.120 for solids sampled right after drying and after 6 days of storage at ambient temperature, respectively.

### EXAMPLE 19

### Stability of MET-A+HO-IBAO as an Isolated Product (Al/Zr=300)

The procedure of Example 17 was followed except that MET-A (100 μmol) and HO-IBAO in hexane (30 mmol Al) were used and no additional hexane was used. After drying, 3.2 g of a purple-brown solid was isolated. The results of the UV-Vis monitoring are summarized in Table 3.

TABLE 3
Change of UV-Vis Absorbance at 600 nm with Time

| Storage Time | Product of Example 19 |
|---|---|
| Right after drying | 0.205 |
| 11 Days | 0.178 |
| 24 Days | 0.177 |

### EXAMPLE 20

### Stability of MET-A+HO-IBAO as an Isolated Product (Al/Zr=60)

The HO-IBAO used in this Example is more freshly prepared than that in the Example 18. As a consequence, no toluene was needed to dissolve the metallocene. Thus, the procedure in the Example 17 was followed except that MET-A (200 μmol), HO-IBAO in hexane (12 mmol Al), and an additional 4 g of hexane were used. After drying, 1.35 g of a purple-brown solid were isolated. The results of the UV-Vis monitoring are summarized in Table 4.

TABLE 4
Change of UV-Vis Absorbance at 600 nm with Time

| Storage Time | Product of Example 20 |
|---|---|
| Right after drying | 0.121 |
| 6 Days | 0.122 |
| 20 Days | 0.132 |

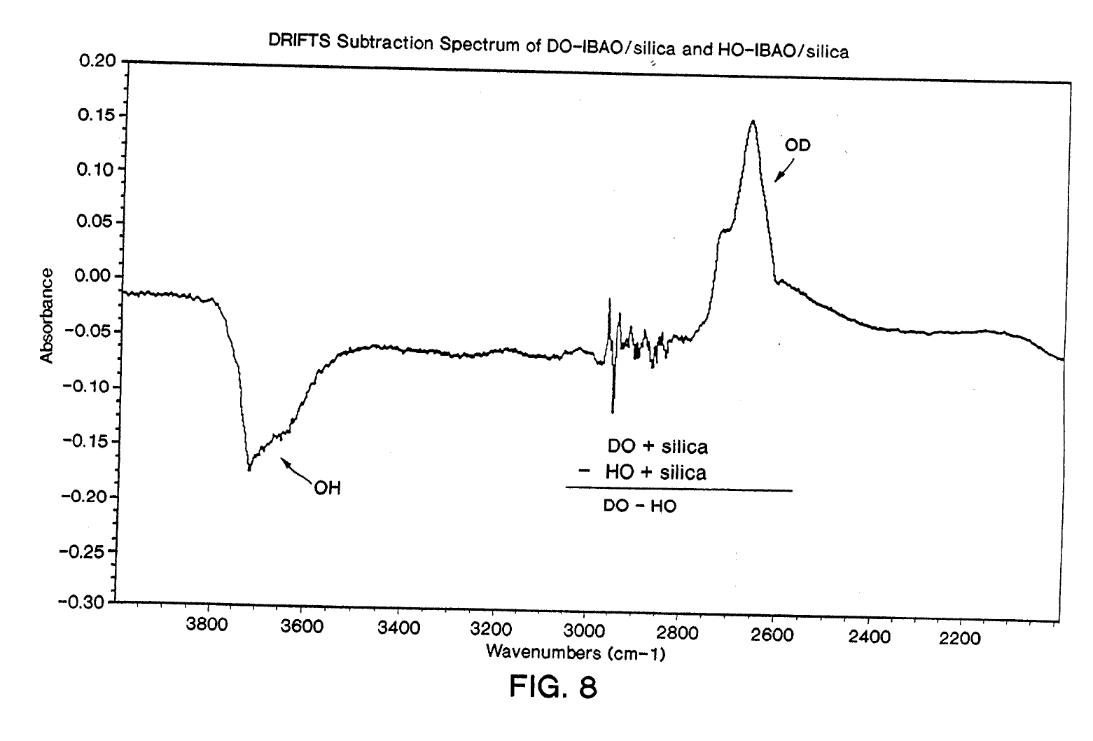

For the following Examples 21-44, it will be noted that the hydroxyaluminoxane/silica materials were more difficult to characterize using DRIFTS. Without desiring to be bound by theory, it is believed that the difficulties arise from the many types of OH groups, external or internal, existing in silica which overlap with the OH groups of hydroxyaluminoxane in the 3600-3800 cm-1 region in IR (the internal OH groups of silica may be particularly troublesome since they cannot be eliminated by calcination or AlR₃ treatment). To overcome this problem, deuterated DO-IBAO was prepared by using D₂O in the hydrolysis of TIBA and the deuterated DO-IBAO was compared spectroscopically with HO-IBAO of identical composition. FIG. 8 shows the subtraction result of the DRIFTS spectra of the two materials; one bears OH (negative adsorptions, 3600-3800 cm−1) and another OD (positive adsorptions, 2600-2800 cm−1). The subtracted spectrum eliminates the adsorption components from the silica's OH groups and, thus, unambiguously proves the existence of the OH groups from IBAO.

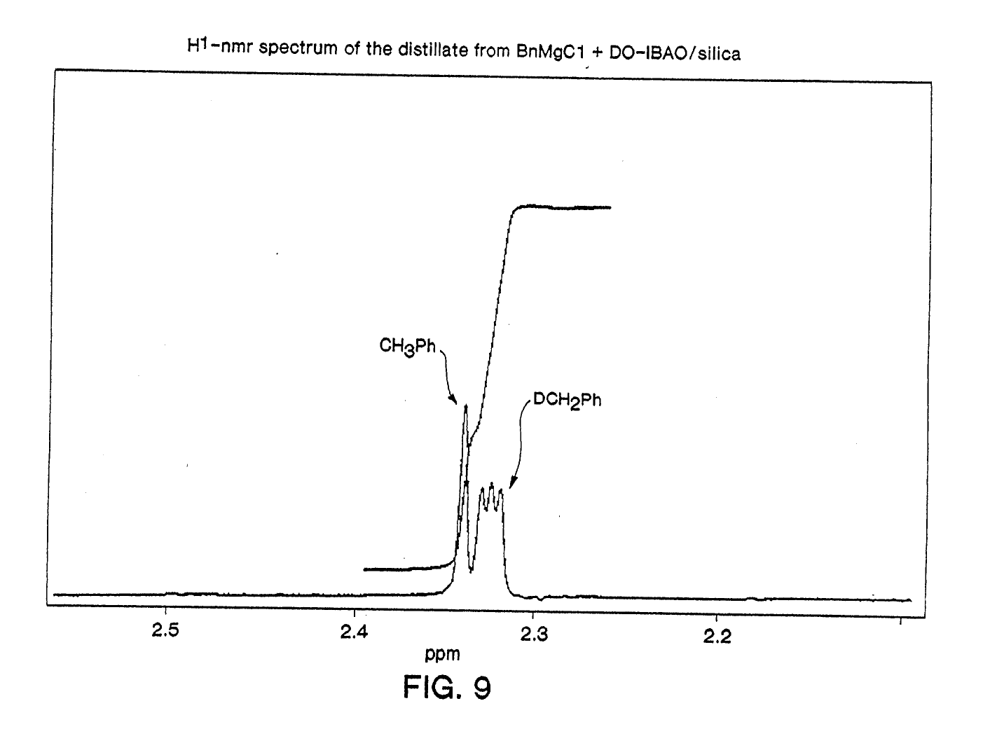

Another problem encountered in characterizing the hydroxyaluminoxane/silica is the quantitative analysis of this class of material. Again without desiring to be bound to theory, it is believed that the DRIFTS spectroscopy is inadequate in this respect because the height of the adsorption (see FIG. 8) is somewhat sensitive to the material's surface area and its packing and flatness in the sample holder. Consequently, a chemical method was designed for quantifying the OH groups. Again, the deuterated DO-IBAO proved to be useful. Treatment of DO-IBAO/silica with an excess of benzylmagnesium chloride solution generated mono-deuterated toluene (DCH₂Ph) which was then collected by vacuum distillation. FIG. 9 shows the H¹-nmr spectrum of such a distillate in CDCl₃. The great virtue of this method is believed to be that the methyl group resonances of DCH₂Ph and toluene are sufficiently resolved to allow easy integration. Toluene was present in the distillate because the commercial benzyl Grignard reagent contained some toluene and the surface OH of silica can also contribute to toluene formation. With this method in hand, we were then able to study the stability of the OH groups on HO-IBAO/silica. Two samples of DO-IBAO/silica were prepared for this study: Sample (1)—silica no treatment; IBAO with a hydrolysis ratio of 1.04, and Sample (2)—silica treated with excess TEA; IBAO with a hydrolysis ratio of 1.16. The loadings of the IBAO on silica were about 35% by weight for sample (1) and about 24% by weight for sample (2).

FIG. 8 shows the OD decay of the two samples and their comparison with that of the soluble HO-IBAO (hydrolysis ratio 1.0). The sample (1), in which silica was not treated with AlR3, has a decay profile that is quite similar to that of the soluble HO-IBAO except that its lifetime is longer at room temperature than that of soluble HO-IBAO at −10° C. The sample (2) was hydrolyzed more, thereby having more than 10 OH groups per 100 aluminums at the start. Strikingly, it has an OH decay profile that is very different from the other two. It features an almost linear decay and is a lot steeper, undoubtedly a result of its silica pre-treatment with TEA.

### EXAMPLES 21-27

### Synthesis of HO-IBAO/Silica

Preparations of all HO-IBAO/silica are summarized in Table 5. Silica, obtained from Crosfield (ES-70), was calcined either at 200° C. or 600° C. for 4 hours. Some of them were pre-treated with AlR₃ (dilute TEA or TIBA in hexane) at room temperature for one hour followed by filtration.

A typical procedure is as follows (Example 27): To a freshly prepared hydroxy IBAO solution in hexane (61.4 g, 87 mmol Al, hydrolysis ratio=1.04) was added silica (15.0 g, calcined at 600° C., no AlR₃ treatment) and stirred with a magnetic stir bar for 2 hours. After that, the slurry was allowed to settle. At this point, if there is an appreciable amount of supernatant, it may be separated from silica by decant (see Table 5). In this example, there was no decant. Instead, the slurry was stripped of volatiles under vacuo, which was done slowly to prevent loss of fine silica particles. After drying, 23.0 g of HO-IBAO/silica was collected, a 34.8% of IBAO loading. The ICP analysis of this solid showed 10.0 wt % Al. For deuterium-labeled DO-IBAO/silica samples (Example 28), this procedure was followed except that D₂O instead of H₂O was used.

TABLE 5
Summary of HO-IBAO/silica preparation

| | Silica | | | IBAO | | | | |
|---|---|---|---|---|---|---|---|---|
| | calcine | | | Hydrolysis | reaction | | loading | |
| Ex. | (° C.) | A1R₃ | wt % Al | ratio | time (hr) | decant | (wt %) | wt % Al (total) |
| 21 | 600 | TEA | 3.0 | 1.18 | 16 | no | 23.8 | 10.1 |
| 22 | 200 | TIBA | 3.2 | 1.18 | 16 | yes | 22.1 | 9.86 |
| 23 | 600 | no | 0.00 | 1.18 | 16 | no | 23.7 | 7.53 |
| 24 | 600 | no | 0.00 | 1.18 | 4 | yes | 33.2 | 10.0 |
| 25 | 600 | TEA | 3.3 | 1.18 | 18 | no | 24.5 | 10.2 |
| 26 | 600 | TEA | 3.3 | 1.18 | 4 | yes | 20.5 | 8.9 |
| 27 | 600 | no | 0.00 | 1.04 | 2 | no | 34.8 | 10.0 |

### EXAMPLE 28

### Quantifying the OD Groups in DO-IBAO/Silica

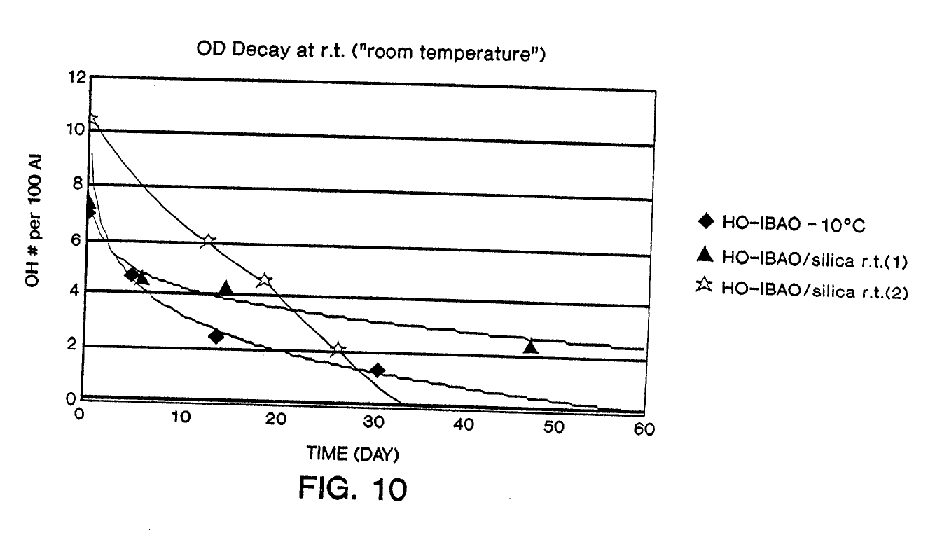

For quantitative purposes, because silica was used as the carrier material, the use of a deuterium-labeled DO-hydroxyaluminoxane/silica, and in this case DO-IBAO/silica, was preferred. Samples (1) and (2) were stored at room temperature in a dry box and were sampled periodically for quantitative analysis (see FIG. 10). A typical procedure was as follows. To the sample (1) DO-IBAO/silica (3.0 g, 11.1 mmol Al) in a round-bottomed flask was added a 2.0M solution of benzylmagnesium chloride in THF (4.80 g). Additional THF (4.5 g) was added to aid stirring. The slurry was stirred for one hour at room temperature. After that all volatiles were carefully vacuum-distilled off the solid residue at temperatures finally reaching 55° C. and collected in a liquid nitrogen trap. The amount of DCH₂Ph in the volatiles collected was determined by H¹-nmr in CDCl₃. From that, the hydroxyl content was determined to be 7.5 OD per 100 aluminums.

### EXAMPLES 29-35

### Preparation of Catalyst from Rac-Dimethylsilylbis(2-methylindenyl)zirconium Dimethyl Activated by HO-IBAO/Silica

The synthesis of HO-IBAO activated silica-supported catalysts (see Table 6 for summary) is exemplified as follows (Example 35): To a slurry of HO-IBAO/silica (1.45 g) in hexane (12 mL) was added particulate rac-dimethylsilylbis(2-methylindenyl)zirconium dimethyl (86 mg) and the mixture was allowed to stir at room temperature. After 75 minutes, the resulting deep brown slurry was filtered, solids washed several times with hexane until the filtrate was colorless, and suction dried for 10 minutes to give a yellowish brown solid, weighing 1.42 g. The ICP analysis of this solid showed 8.8 wt % Al and 1.0 wt % Zr, which corresponds to a Al/Zr molar ratio of 29.

TABLE 6
Properties of rac-dimethylsilylbis(2-methylindenyl)zirconium
dimethyl/HO-IBAO/silica catalysts

Catalyst

| Example | IBAO/silica | wt % Al | wt % Zr | Al/Zr |
|---|---|---|---|---|
| 29 | 21 | 10.2 | 0.46 | 53 |
| 30 | 22 | 8.1 | 0.54 | 51 |
| 31 | 23 | 8.4 | 0.43 | 41 |
| 32 | 24 | 10.1 | 1.3 | 26 |
| 33 | 25 | 8.7 | 0.46 | 64 |
| 34 | 26 | 7.6 | 0.40 | 65 |
| 35 | 27 | 8.8 | 1.0 | 29 |

### EXAMPLES 36-42

For each catalyst synthesized in Examples 29-35, polymerization of propylene was carried out in a 4-liter reactor charged with 2200 mL of liquid propylene. At 65° C. with vigorous stirring, 1.0 mL of 5% TIBA (as scavenger) was injected into the reactor first, which was quickly followed by another injection of the catalyst (110 mg slurried in 2 mL of dry hexane) to initiate polymerization. After one hour of reaction, the unreacted propylene was quickly vented. The results are summarized in Table 7. No reactor fouling was seen in any of the polymerizations.

TABLE 7
Summary of propylene polymerization results

| | | | | | Polymer | | | | | |
|---|---|---|---|---|---|---|---|---|---|---|
| | | | | Catalyst | Bulk | | | | | |
| | | Catalyst | Polymer | Activity | Density | Melting Point | MFI | GPC | | |
| Ex. | Catalyst | weight (mg) | Yield (g) | (g/g/h) | (g/mL) | (onset/peak) (° C.) | (230° C./5 kg) | Mw | Mn | Mw/Mn |
| 36 | 29 | 154 | 396 | 2568 | 0.37 | 144.58/150.08 | 35.89 | — | — | — |
| 37 | 30 | 206 | 15 | 73 | 0.28 | — | — | — | — | — |
| 38 | 31 | 165 | 367 | 2218 | 0.40 | 143.52/149.39 | 39.73 | 253000 | 147000 | 1.72 |
| 39 | 32 | 164 | 247 | 1506 | 0.28 | 143.25/149.09 | 31.93 | 300000 | 180000 | 1.67 |
| 40 | 33 | 160 | 170 | 1059 | 0.21 | 142.28/148.85 | 34.54 | 261000 | 157000 | 1.66 |
| 41 | 34 | 161 | 39 | 243 | 0.15 | — | — | — | — | — |
| 42 | 35 | 41 | 185 | 4512 | 0.38 | 143.01/148.85 | 28.47 | 267000 | 155000 | 1.72 |

### EXAMPLE 43

### Preparation of Catalyst from Rac-Ethylene Bis(tetrahydroindenyl)zirconium Dimethyl Activated by HO-IBAO/Silica

The synthesis of this silica-supported catalyst was as described in examples 29-35 except that HO-IBAO/silica (1.98 g), hexane (18 mL), and rac-ethylene bis(tetrahydroindenyl)zirconium dimethyl (160 mg) were used and the mixture was allowed to stir at room temperature for 85 minutes. The product was a pink solid, weighing 1.97 g. The ICP analysis of this solid showed 8.8 wt % Al and 1.3 wt % Zr, which corresponds to a Al/Zr molar ratio of 23.

### EXAMPLE 44

### Ethylene Polymerization

The polymerization was carried out in a 4-liter reactor which was charged with 1000 mL of isobutane and 40 mL hexene (pushed in by another 500 mL of isobutene), sequentially. After stabilizing at 80° C., the reactor was pressurized with ethylene from 145 psig to 345 psig. With vigorous stirring (600 rpm), 2.0 mL of 5% TIBA (as scavenger) was injected into the reactor first, which was quickly followed by an injection of the catalyst from Example 43 (77.7 mg slurried in 3 mL of dry hexane) to initiate polymerization. The reactor pressure was maintained at 315 psig by adding more make up ethylene. After one hour of reaction, unreacted ethylene and isobutane were quickly vented. The polyethylene fluff after drying weighed 198 g. No reactor fouling was seen. Polymer properties: bulk density: 0.31 g/cc; M.P.: 109.17/121.09° C. (onset of second melt/peak). Melt flow index (190° C./5 kg) was too low to measure (<0.1 g/10 min). Molecular weight via GPC was as follows: Mw=640,000, Mn=296,000, Mw/Mn=2.16.

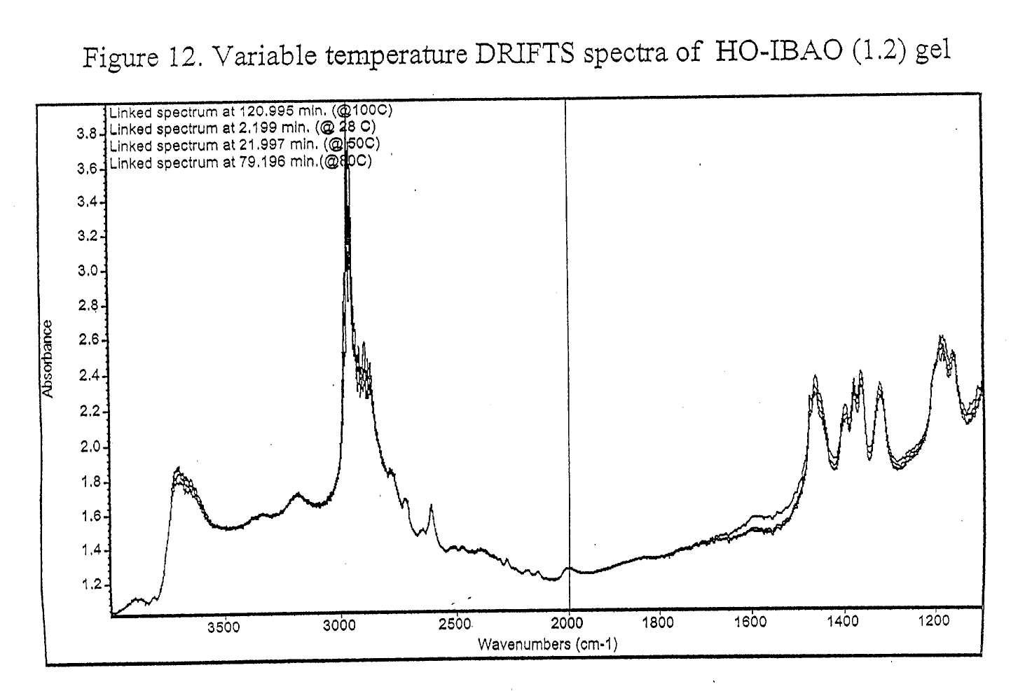

In the following Examples 45-48, it will be seen that one solution for solving the instability problem of the OH groups is by isolating the hydroxyaluminoxane as an insoluble gel or a solid formed from such a gel. Gelation of hydroxyaluminoxane occurs when the water to aluminum molar ratio exceeds a certain amount, which amount is dependent upon the hydroxyaluminoxane involved. In one case (Example 45 below), triisobutylaluminum was hydrolyzed with about 1.2 equivalents of water. The resulting HO-IBAO(1.2) became an insoluble gel which could be isolated as a solid material after solvent stripping. FIG. 11 shows the FT-IR spectrum in the OH region of the IBAO(1.2) gel (after solvent stripping) overlayed with that of the hexane-soluble IBAO(1.0) for comparison. The IBAO(1.2) gel shown was stored at ambient temperature for a few weeks and still contained no lesser amount of OH groups that in the freshly prepared soluble IBAO(1.0). Furthermore, not only did IBAO(1.2) gel not show the OH-decay at ambient temperature but also the resulting OH groups were remarkably stable even at elevated temperatures. FIG. 12 is a set of four DRIFTS (diffuse reflectance infrared fourier transform spectroscopy) spectra of HO-IBAO(1.2) taken at 28° C. (2 min), 50° C. (20 min), 80° C. (57 min), and 100° C. (40 min) with the time spent at each temperature as indicated. It is only at 100° C. that the OH groups start to diminish at a very slow rate. Without being bound to theory, it is believed that this enhanced stability is a result of gelation which allows the OH groups to be immobilized in the polymeric matrix of the gels and, hence, stabilized. It will be appreciated from this disclosure that, like soluble versions of hydroxyaluminoxane, this insoluble gelatinous material, and the solids derived therefrom, contain hydroxyl groups which can be used to activate organometallic compounds via a Brønsted acid mechanism. Unlike soluble aluminoxane, however, the gels and/or the solids derived therefrom serve both as an activator and as a support. This dual role played by the hydroxy aluminoxane gels and/or solid material derived therefrom allows the resulting catalysts to be more stable and to be non-fouling in the polymerization reactor.

### EXAMPLE 45

### Synthesis of Hydroxyisobutylaluminoxane Gels

To a TIBA (60.6 g) solution in hexane (193 g) was added water drop wise in two portions. The first portion of water (5.6 g) was added at temp of 0 to −5° C. over one hour, then the solution temp was raised to 25° C., and at that temp another 1.0 g of water was added over 50 minutes. The total amount of water added was 1.19 eq. (water/Al=1.19). During the latter stage of second water addition, some small amount of gel started to form. The solution was put in vacuo to remove hydrolysis by-product, isobutane, and allowed to stir at 15° C. overnight. After 16 hrs of stirring at 15° C., the solution produced lots of gel. Such gelation would continue to a noticeable degree over the next 24 hrs. After that, the amount of gel produced was such that the gel-solution was difficult to pour having very little free-flowing hexanes left.

### EXAMPLE 46

### Preparation of Rac-Dimethylsilylbis(2-methylindenyl)zirconium Dimethyl Catalyst by Solid HO-IBAO Gels

To the gel-solution (12.24 g) produced above (in Example 45) with stirring was added solid rac-dimethylsilylbis(2-methylindenyl)zirconium dimethyl (43 mg). The light yellow metallocene gradually dissolved and turned the gel-solution from colorless to dark brown. After 18 minutes of stirring, the dark brown slurry was stripped off volatiles in vacuo to give a somewhat tacky brown residue, weighing 1.8 g. When this material was used in a bulk propylene polymerization, the catalyst activity was quite high but severe reactor fouling occurred. To avoid fouling, the soluble portion of the tacky brown residue was removed by washing consecutively by hexane (15 mL) and toluene (25 mL) and filtered. The toluene slurry was difficult to filter, so the colored supernatant was decanted. The resulting brown material was pumped to dryness to give now a non-tacky solid, weighing 1.18 g. The ICP analysis of this solid showed 30.0 wt % Al and 0.43 wt % Zr.

### EXAMPLE 47

### Propylene Polymerization

Polymerization of propylene was carried out in a 4-liter reactor charged with 2200 mL of liquid propylene. At 65° C. with vigorous stirring, 1.0 mL of 5% TIBA (as scavenger) was injected into the reactor first, which was quickly followed by another injection of the catalyst from Example 46 (110 mg slurried in 2 mL of dry hexane) to initiate polymerization. After one hour of reaction, the unreacted propylene was quickly vented. After drying, 153 g of irregular shaped granulates having 78% >2000 microns were collected. No reactor fouling was seen. Polymer properties: bulk density: 0.26 g/cc; M.P.: 142.42/148.97° C. (onset of second melt/peak); MFI (230° C./5 kg): 39.93 g/10 min.

### EXAMPLE 48

In example 47, the catalyst gel solids were apparently too big, which resulted in a very large polymer particle size and reduced catalyst activity. Therefore, the same brown solid catalyst was ground to finer particles using a mortar/pestle. Repeating the polymerization using the resulting finer particles (67.2 mg) for one hour produced 222 g of polymer. Thus, simply by grinding the catalyst particles, the catalyst productivity was improved from 1391 g/g/h in polymerization-1 to 3304 g/g/h in polymerization-2. Again, there was no reactor fouling. Polymer properties: bulk density=0.27 g/cc; M.P.=142.33/148.66° C. (onset of second melt/peak); molecular weight data (via GPC): Mw=256,000, Mn=131,000, Mw/Mn=1.95.

While this invention has been specifically illustrated by reactions between a metallocene and a hydroxyaluminoxane, it is to be understood that other suitable organometallic reactants having an appropriate leaving group can be employed. For example it is contemplated that the organometallic complexes described in the following publications will form ionic compounds of this invention, provided that at least one of the halogen atoms bonded to the d-block or f-block metal atom is replaced by a suitable leaving group such as a methyl, benzyl, or trimethylsilylmethyl group:

Small, B. L.; Brookhart, M.; Bennett, A, M. A. J. Am. Chem. Soc. 1998, 120, 4049.

Small, B. L.; Brookhart, M. J. Am. Chem. Soc. 1998, 120 7143.

Johnson, L. K.; Killian, C. M.; Brookhart, M. J. Am. Chem. Soc. 1995, 117, 6414.

Killian, C. M.; Johnson, L. K.; Brookhart, M. Organometallics 1997, 16, 2005.

Killian, C. M.; Tempel, D. J.; Johnson, L. K.; Brookhart, M. J. Am. Chem. Soc. 1996, 118, 11664.

Johnson, L. K.; Mecking, S.; Brookhart, M. J. Am. Chem. Soc. 1996, 118, 267.

It will now be appreciated that this invention is susceptible to consideration variation in its practice, as the invention provides numerous advantages and features. Some of these advantages and features for each aspect of this invention can be expressed in terms of the various embodiments of the invention itself. The following comprises non-limiting examples of such embodiments for each aspect of the invention (NB: numerical and/or letter references to previous embodiments (e.g., A1) within each aspect's list of embodiments provided below are to be understood to refer only to the previously listed embodiment(s) which have the reference number(s) given and which is/are within that aspect's list of embodiments):

First Aspect

A1. A compound which is formed by bringing together at least a d-block or f-block metal compound and an hydroxyaluminoxane, wherein said compound after recovery is stored in an anhydrous, inert atmosphere or environment, and except during one or more optional finishing procedures, if and when performed, is in undissolved form.

A2. A compound according to A1 wherein the metal of said metal compound is a metal of Group 4.

A3. A compound according to A1 wherein the leaving group is a hydrocarbyl group bonded directly to said d-block or f-block metal compound.

A4. A compound according to A1 wherein the leaving group is a methyl group bonded directly to said d-block or f-block metal compound.

A5. A compound according to A4 wherein the metal of said metal compound is a metal of Group 4.

A6. A compound according to A1 wherein said hydroxyaluminoxane functions as a Bronsted acid.

A7. A compound according to A1 wherein said hydroxyaluminoxane has a ratio of less than one hydroxyl group per aluminum atom.

A8. A compound according to A1 wherein the hydroxyaluminoxane is an alkylaluminoxane in which at least one aluminum atom has a hydroxyl group bonded thereto, and in which the alkyl groups each contain at least two carbon atoms.

A9. A compound according to A8 wherein the alkyl groups are isobutyl groups.

A10. A compound according to A9 wherein the metal of said metal compound is zirconium.

A11. A compound according to A1 wherein said metal compound is a metallocene.

A12. A compound according to A1 wherein said metal compound has at least two leaving groups bonded to said d-block or f-block metal.

A13. A compound according to A1 wherein said metal compound has a single leaving group bonded at two different sites to said d-block or f-block metal.

A14. A compound according to A1 wherein said metal compound is rac-dimethylsilylbis(2-methylindenyl)zirconium dimethyl.

A15. A compound according to A1 wherein said metal compound is bis(1-butyl-3-methylcyclopentadienyl)zirconium dimethyl.

A16. A compound according to A14 wherein said hydroxyaluminoxane is an isobutylaluminoxane in which at least one aluminum atom has a hydroxyl group bonded thereto.

A17. A compound according to A15 wherein said hydroxyaluminoxane is an isobutylaluminoxane in which at least one aluminum atom has a hydroxyl group bonded thereto.

A18. A compound according to any of A1-A17 wherein said compound after recovery is stored in an anhydrous, inert atmosphere or environment, and except during one or more optional finishing procedures is (a) in undissolved isolated form or (b) in undissolved form supported on a catalyst support.

B1. A compound which comprises a cation derived from a d-block or f-block metal compound by loss of a leaving group and an aluminoxate anion devoid of said leaving group, wherein said compound comprised of said cation and said aluminoxate anion is maintained in undissolved form in a dry, inert atmosphere or environment after the compound has been formed.

C1. A compound which comprises a cation derived from a d-block or f-block metal compound by loss of a leaving group transformed into a neutral hydrocarbon, and an aluminoxate anion derived by loss of a proton from a hydroxyaluminoxane having, prior to said loss, at least one aluminum atom having a hydroxyl group bonded thereto, wherein said compound comprised of said cation and said aluminoxate anion is maintained in undissolved form in a dry, inert atmosphere or environment during a storage period.

D1. A compound according to either B1 or C1 wherein the compound while maintained in said undissolved form is in isolated form, or is in supported form on a catalyst support material.

E1. A process which comprises bringing together a d-block or f-block metal compound having one or more leaving groups with a hydroxyaluminoxane in which at least one aluminum atom has a hydroxyl group bonded thereto so that a metal-containing product compound is formed; recovering said product compound; storing the recovered product compound in an anhydrous, inert atmosphere or environment; and maintaining said product compound in undissolved form except during one or more optional finishing procedures, if any such finishing procedure is performed.

E2. A process according to E1 wherein one of said leaving groups is lost in the form of a hydrocarbon.

E3. A process according to E1 wherein the metal of said metal compound is a metal of Group 4.

E4. A process according to E1 wherein at least one of said leaving groups is a hydrocarbyl group bonded directly to said d-block or f-block metal compound.

E5. A process according to E1 wherein at least one of said leaving groups that is lost is a methyl group bonded directly to said d-block or f-block metal compound.

E6. A process according to E5 wherein the metal of said metal compound is a metal of Group 4.

E7. A process according to E1 wherein said hydroxyaluminoxane is transformed into an aluminoxate anion by functioning as a Bronsted acid.

E8. A process according to E7 wherein said hydroxyaluminoxane has a ratio of less than one hydroxyl group per aluminum atom.

E9. A process according to E1 wherein said hydroxyaluminoxane is an alkylaluminoxane in which at least one aluminum atom has a hydroxyl group bonded thereto, and in which the alkyl groups each contain at least two carbon atoms.

E10. A process according to E9 wherein the alkyl groups are isobutyl groups.

E11. A process according to E10 wherein the metal of said metal compound is zirconium.

E12. A process according to E1 wherein said metal compound is a metallocene.

E13. A process according to E1 wherein said metal compound is rac-dimethylsilylbis(2-methylindenyl)zirconium dimethyl.

E14. A process according to E1 wherein said metal compound is bis(1-butyl-3-methylcyclopentadienyl)zirconium dimethyl.

E15. A process according to E13 wherein said hydroxyaluminoxane is an isobutylaluminoxane in which at least one aluminum atom has a hydroxyl group bonded thereto.

E16. A process according to E14 wherein said hydroxyaluminoxane is an isobutylaluminoxane in which at least one aluminum atom has a hydroxyl group bonded thereto.

E17. A process according to any of E1-E16 wherein the metal-containing product compound while being maintained in said undissolved form is in isolated form, or is in supported form on a catalyst support material.

F1. A process which comprises donating a proton from an aluminoxane to a leaving group of a d-block or f-block metal compound to form a product compound composed of a cation derived from said metal compound and an aluminoxate anion devoid of said leaving group; recovering said product compound; storing the recovered product compound in an anhydrous, inert atmosphere or environment; and maintaining said product compound in undissolved form except during one or more optional finishing procedures, if any such finishing procedure is performed.

G1. A process which comprises interacting a d-block or f-block metal compound having at least one leaving group and a hydroxyaluminoxane having at least one aluminum atom that has a hydroxyl group bonded thereto to form a product compound composed of a cation through loss of a leaving group which is transformed into a neutral hydrocarbon, and an aluminoxate anion derived by loss of a proton from said hydroxyaluminoxane; recovering said product compound; storing the recovered product compound in an anhydrous, inert atmosphere or environment; and maintaining said product compound in undissolved form except during one or more optional finishing procedures, if any such finishing procedure is performed.

G2. A process according to G1 wherein prior to said interaction, said d-block or f-block metal compound has at least two leaving groups bonded to said d-block or f-block metal.

G3. A process according to G1 wherein prior to said interaction, said compound has a single leaving group bonded at two different sites to said d-block or f-block metal.

G4. A process according to any of F1-G3 wherein the metal-containing product compound while being maintained in said undissolved form is in isolated form, or is in supported form on a catalyst support material.

Second Aspect

A1. A composition in the form of one or more individual solids, which composition is formed from components comprised of (i) a hydroxyaluminoxane and (ii) a carrier material compatible with said hydroxyaluminoxane and in the form of one or more individual solids, said composition having a reduced OH-decay rate relative to the OH-decay rate of (i).

A2. A composition according to A1 wherein (i) is supported on (ii).

A3. A composition according to A2 wherein (ii) consists essentially of a particulate inorganic catalyst support material.

A4. A composition according to A3 wherein said inorganic catalyst support material is comprised of anhydrous or substantially anhydrous particles of silica, silica-alumina, or alumina.

A5. A composition according to A3 wherein said inorganic catalyst support material consists essentially of a particulate porous calcined silica.

A6. A composition according to A3 wherein said inorganic catalyst support material consists essentially of a particulate porous silica pretreated with an aluminum alkyl.

A7. A composition according to any of A1, A2, A3, A4, A5, or A6 wherein said hydroxyaluminoxane of (i) has less than 25 OH groups per 100 aluminum atoms.

A8. A composition according to any of A1, A2, A3, A4, A5, or A6 wherein said hydroxyaluminoxane of (i) consists essentially of hydroxyisobutylaluminoxane.

A9. A composition according to any of A1, A2, A3, A4, A5, or A6 wherein said composition is substantially insoluble in an inert organic solvent.

A10. A composition according to A9 wherein said hydroxyaluminoxane of (i) has less than 25 OH groups per 100 aluminum atoms.

A11. A composition according to A9 wherein said hydroxyaluminoxane of (i) consists essentially of hydroxyisobutylaluminoxane.

A12. A composition according to any of A1, A2, A3, A4, A5, or A6 wherein the OH-decay rate of said composition is reduced relative to the OH-decay rate of (i) by a factor of at least 5.

A13. A composition according to A12 wherein said hydroxyaluminoxane of (i) has less than 25 OH groups per 100 aluminum atoms.

A14. A composition according to A12 wherein said hydroxyaluminoxane of (i) consists essentially of hydroxyisobutylaluminoxane.

A15. A composition according to A12 wherein said composition is substantially insoluble in an inert organic solvent.

B1. A composition comprising a hydroxyaluminoxane supported on a solid support.

B2. A composition according to B1, wherein said composition is characterized by having an OH-decay rate which is reduced as compared to the OH-decay rate of the hydroxyaluminoxane in a liquid or solid unsupported form.

B3. A composition according to B2 wherein the OH-decay rate of said composition is reduced, as compared to that of said hydroxyaluminoxane in unsupported form, by a factor of at least 5.

B4. A composition according to any of B1, B2, or B3 wherein said hydroxyaluminoxane has less than 25 hydroxyl groups per 100 aluminum atoms.

B5. A composition according to any of B1, B2, or B3 wherein said hydroxyaluminoxane consists essentially of hydroxyisobutylaluminoxane.

B6. A composition according to any of B1, B2, or B3 wherein said solid support is a particulate inorganic catalyst support material.

B7. A composition according to B6 wherein said inorganic catalyst support material is comprised of anhydrous or substantially anhydrous particles of silica, silica-alumina, or alumina.

B8. A composition according to B6 wherein said inorganic catalyst support material consists essentially of a particulate porous silica pretreated with an aluminum alkyl.

C1. A process comprising converting a hydroxyaluminoxane into a composition in the form of one or more individual solids by bringing together (i) a hydroxyaluminoxane and (ii) a carrier material compatible with said hydroxyaluminoxane and in the form of one or more individual solids, whereby the rate of OH-decay for said composition is reduced relative to the rate of OH-decay of (i).

C2. A process according to C1 wherein (i) is converted into said composition by supporting (i) on (ii).

C3. A process according to C2 wherein (ii) consists essentially of a particulate inorganic catalyst support material.

C4. A process according to C3 wherein said inorganic catalyst support material is comprised of anhydrous or substantially anhydrous particles of silica, silica-alumina, or alumina.

C5. A process according to C3 wherein said inorganic catalyst support material consists essentially of a particulate porous calcined silica.

C6. A process according to C3 wherein said inorganic catalyst support material consists essentially of a particulate porous silica pretreated with an aluminum alkyl.

C7. A process according to any of C1, C2, C3, C4, C5, or C6 wherein said hydroxyaluminoxane of (i) has less than 25 OH groups per 100 aluminum atoms.

C8. A process according to C7 wherein said hydroxyaluminoxane of (i) consists essentially of hydroxyisobutylaluminoxane.

C9. A process according to any of C1, C2, C3, C4, C5, or C6 wherein the OH-decay rate of said composition is reduced, as compared to the OH-decay rate of (i), by a factor of at least 5.

C10. A process according to C9 wherein said hydroxyaluminoxane of (i) has less than 25 OH groups per 100 aluminum atoms.

C11. A process according to C10 wherein said hydroxyaluminoxane of (i) consists essentially of hydroxyisobutylaluminoxane.

C12. A process according to C9, wherein said composition is insoluble or substantially insoluble in an inert organic solvent.

D1. A supported activated catalyst composition formed by bringing together (A) a composition in the form of one or more individual solids, which composition is formed from components comprised of (i) a hydroxyaluminoxane and (ii) a carrier material compatible with said hydroxyaluminoxane and in the form of one or more individual solids, said composition of (A) having a reduced OH-decay rate relative to the OH-decay rate of (i); and (B) a d- or f-block metal compound having at least one leaving group on a metal atom thereof.

D2. A catalyst composition according to D1 wherein said d- or f-block metal compound is a Group 4 metal.

D3. A catalyst composition according to D1 wherein said d- or f-block metal compound is a metallocene.

D4. A catalyst composition according to D3 wherein the d- or f-block metal of said metallocene is at least one Group 4 metal.

D5. A catalyst composition according to D3 wherein said metallocene contains two bridged or unbridged cyclopentadienyl-moiety-containing groups.

D6. A catalyst composition according to D5 wherein the Group 4 metal of said metallocene is zirconium.

D7. A catalyst composition according to D5 wherein the Group 4 metal of said metallocene is titanium.

D8. A catalyst composition according to D5 wherein the Group 4 metal of said metallocene is hafnium.

D9. A catalyst composition according to any of D1, D2, D3, D4, D5, D6, D7, or D8 wherein said hydroxyaluminoxane of (i) has less than 25 hydroxyl groups per 100 aluminum atoms.

D10. A catalyst composition according to any of D1, D2, D3, D4, D5, D6, D7, or D8 wherein said hydroxyaluminoxane of (i) consists essentially of hydroxyisobutylaluminoxane.

D11. A catalyst composition according to any of D1, D2, D3, D4, D5, D6, D7, or D8 wherein (ii) consists essentially of a particulate inorganic catalyst support material.

D12. A catalyst composition according to D11 wherein said catalyst support material is comprised of anhydrous or substantially anhydrous particles of silica, silica-alumina, or alumina.

D13. A catalyst composition according to D11 wherein said inorganic catalyst support material consists essentially of a particulate porous calcined silica.

D14. A catalyst composition according to D11 wherein said inorganic catalyst support material consists essentially of a particulate porous silica pretreated with an aluminum alkyl.

D15. A catalyst composition according to any of D1, D2, D3, D4, D5, D6, D7, or D8 wherein said composition in a dry or substantially dry state is able to be maintained at a temperature in the range of 10 to 60° C. for a period of at least 48 hours without losing fifty percent (50%) or more of its catalytic activity.

E1. A process of preparing a supported activated catalyst, which process comprises bringing together (A) a composition in the form of one or more individual solids formed by bringing together (i) a hydroxyaluminoxane and (ii) a carrier material compatible with said hydroxyaluminoxane and in the form of one or more individual solids, whereby the rate of OH-decay for said composition is reduced relative to the rate of OH-decay of (i); and (B) a d- or f-block metal compound having at least one leaving group on a metal atom thereof.

E2. A process according to E1 wherein (A) and (B) are brought together in an inert diluent.

E3. A process according to E1 wherein (A) and (B) are brought together in the absence of an inert diluent.

E4. A process according to E1 wherein said hydroxyaluminoxane of (i) consists essentially of hydroxyisobutylaluminoxane.

E5. A process according to E1 wherein said hydroxyaluminoxane of (i) has less than 25 hydroxyl groups per 100 aluminum atoms.

E6. A process according to E1 wherein (ii) is a particulate inorganic catalyst support material.

E7. A process according to E6 wherein said inorganic catalyst support material is comprised of anhydrous or substantially anhydrous particles of silica, silica-alumina, or alumina.

E8. A process according to E6 wherein said inorganic catalyst support material consists essentially of a particulate porous calcined silica.

E9. A process according to E6 wherein said inorganic catalyst support material consists essentially of a particulate porous silica pretreated with an aluminum alkyl.

E10. A process according to E1 wherein said d- or f-block metal compound is a metallocene.

E11. A process according to E10 wherein said at least one leaving group of said metallocene is a methyl group.

E12. A process according to E10 wherein said metallocene contains two bridged or unbridged cyclopentadienyl-moiety-containing groups.

E13. A process according to E12 wherein the metal of said metallocene is a Group 4 metal.

E14. A process according to E13 wherein said Group 4 metal is zirconium.

E15. A process according to E13 wherein said Group 4 metal is titanium.

E16. A process according to E13 wherein said Group 4 metal is hafnium.

E17. A process according to any of E1, E2, E3, E4, E5, E6, E7, E8, E9, E1, E11, E12, E13, E14, E15, or E16, wherein said supported activated catalyst is recovered and maintained at a temperature in the range of 10 to 60° C. for a period of at least 48 hours without losing fifty percent (50%) or more of its catalytic activity.

F1. An olefin polymerization process which comprises bringing together in a polymerization reactor or reaction zone (1) at least one polymerizable olefin and (2) a supported activated catalyst composition which is in accordance with any of C₁, C2, C3, C4, C5, C6, C7, or C8.

F2. An olefin polymerization process according to F1 wherein the polymerization process is conducted as a gas-phase polymerization process.

F3. An olefin polymerization process according to F1 wherein the polymerization process is conducted in a liquid phase diluent.

F4. An olefin polymerization process according to F1 wherein the polymerization process is conducted as a fluidized bed process.

F5. An olefin polymerization process according to F1 wherein said hydroxyaluminoxane of (i) has less than 25 hydroxyl groups per 100 aluminum atoms.

F6. An olefin polymerization process according to F5 wherein the polymerization process is conducted as a gas-phase polymerization process.

F7. An olefin polymerization process according to F5 wherein the polymerization process is conducted in a liquid phase diluent.

F8. An olefin polymerization process according to F5 wherein the polymerization process is conducted as a fluidized bed process.

F9. An olefin polymerization process according to F1 wherein said hydroxyaluminoxane of (i) consists essentially of hydroxyisobutylaluminoxane.

F10. An olefin polymerization process according to F1 wherein (ii) consists essentially of a particulate inorganic catalyst support material.

F11. An olefin polymerization process according to F10 wherein said catalyst support material is comprised of anhydrous or substantially anhydrous particles of silica, silica-alumina, or alumina.

F12. An olefin polymerization process according to F10 wherein said inorganic catalyst support material consists essentially of a particulate porous calcined silica.

F13. An olefin polymerization process according to F10 wherein said inorganic catalyst support material consists essentially of a particulate porous silica pretreated with an aluminum alkyl.

F14. An olefin polymerization process according to F10 wherein the polymerization process is conducted as a gas-phase polymerization process.

F15. An olefin polymerization process according to F10 wherein the polymerization process is conducted in a liquid phase diluent.

F16. An olefin polymerization process according to F10 wherein the polymerization process is conducted as a fluidized bed process.

G1. A catalyst composition formed by bringing together (A) a hydroxyaluminoxane and (B) rac-ethylene bis(1-indenyl)zirconium dimethyl.

G2. A catalyst composition according to G1 wherein (A) and (B) are brought together in an inert diluent.

G3. A catalyst composition according to G1 wherein (A) and (B) are brought together in the absence of an inert diluent.

G4. A catalyst composition according to any of G1, G2, or G3 wherein said hydroxyaluminoxane of (A) has less than 25 hydroxyl groups per 100 aluminum atoms.

G5. A catalyst composition according to G4 wherein said composition in a dry state is able to be maintained at a temperature in the range of 10 to 60° C. for a period of at least 48 hours without losing fifty percent (50%) or more of its catalytic activity.

G6. A catalyst composition according to any of G1, G2, or G3 wherein said hydroxyaluminoxane of (A) consists essentially of hydroxyisobutylaluminoxane.

G7. A catalyst composition according to G6 wherein said composition in a dry state is able to be maintained at a temperature in the range of 10 to 60° C. for a period of at least 48 hours without losing fifty percent (50%) or more of its catalytic activity.

G8. A catalyst composition according to any of G1, G2, or G3 wherein said hydroxyaluminoxane of (A) is supported on a particulate inorganic catalyst support material.

G9. A catalyst composition according to G8 wherein said inorganic catalyst support material is comprised of anhydrous or substantially anhydrous particles of silica, silica-alumina, or alumina.

G10. A catalyst composition according to G8 wherein said inorganic catalyst support material consists essentially of a particulate porous silica pretreated with an aluminum alkyl.

G11. A catalyst composition according to G8 wherein said composition in a dry state is able to be maintained at a temperature in the range of 10 to 60° C. for a period of at least 48 hours without losing fifty percent (50%) or more of its catalytic activity.

H1. A process for the production of a supported hydroxyaluminoxane which comprises bringing together (i) an aluminum alkyl in an inert solvent, (ii) a water source, and (iii) a carrier material, under hydroxyaluminoxane-forming reaction conditions.

H2. A process according to H1 wherein said aluminum alkyl is a trialkylaluminum.

H3. A process according to H1 wherein said water source consists essentially of free water.

H4. A process according to H1 wherein said water source consists essentially of a hydrated inorganic salt or un-dehydrated silica.

H5. A process according to H1 wherein said carrier material is a solid support.

H6. A process according to H5 wherein said solid support is a particulate inorganic catalyst support material.

H7. A process according to H6 wherein said inorganic catalyst support material is comprised of anhydrous or substantially anhydrous particles of silica, silica-alumina, or alumina.

H8. A process according to H6 wherein said inorganic catalyst support material consists essentially of a particulate porous calcined silica.

H9. A process according to H6 wherein said inorganic catalyst support material consists essentially of a particulate porous silica pretreated with an aluminum alkyl.

J1. A method of forming an olefin polymerization catalyst, which method comprises feeding into a vessel (A) a hydroxyaluminoxane and (B) a d- or f-block metal compound in proportions such that an active olefin polymerization catalyst is formed.

J2. A method according to J1 wherein the hydroxyaluminoxane is fed in the form of a solution formed from the hydroxyaluminoxane in an inert solvent or in a liquid polymerizable olefinic monomer, or both.

J3. A method according to J1 wherein the hydroxyaluminoxane is fed in the form of a slurry formed from the hydroxyaluminoxane in an inert diluent or in a liquid polymerizable olefinic monomer.

J4. A method according to J1 wherein the hydroxyaluminoxane is fed in the form of unsupported solid particles.

J5. A method according to J1 wherein the hydroxyaluminoxane is fed in the form of one or more solids on a carrier material.

J6. A method according to J1 wherein the hydroxyaluminoxane is fed in the form of (i) a solution formed from the hydroxyaluminoxane in an inert solvent or in a liquid polymerizable olefinic monomer, or both; (ii) a slurry formed from the hydroxyaluminoxane in an inert diluent or in a liquid polymerizable olefinic monomer; (iii) unsupported solid particles; or (iv) one or more solids on a carrier material; or (v) any combination of two or more of (i), (ii), (iii), and (iv).

J7. A method according to any of J1, J2, J3, J4, J5, or J6 wherein the d- or f-block metal compound is fed in the form of undiluted solids or liquid.

J8. A method according to any of J1, J2, J3, J4, J5, or J6 wherein the d- or f-block metal compound is fed in the form of a solution or slurry of the d- or f-block metal compound in an inert solvent or diluent, or in a liquid polymerizable olefinic monomer, or in a mixture of any of these.

K1. In a process for the catalytic polymerization of at least one olefin in a reaction vessel or reaction zone, the improvement which comprises introducing into the reaction vessel or reaction zone catalyst components comprising (A) a hydroxyaluminoxane and (B) a d- or f-block metal compound, in proportions such that said at least one olefin is polymerized.

K2. The improvement according to K1 wherein the hydroxyaluminoxane is introduced in the form of a solution formed from the hydroxyaluminoxane in an inert solvent or in a liquid form of said at least one olefin, or both.

K3. The improvement according to K1 wherein the hydroxyaluminoxane is introduced in the form of a slurry formed from the hydroxyaluminoxane in an inert diluent or in a liquid form of said at least one olefin.

K4. The improvement according to K1 wherein the hydroxyaluminoxane is introduced in the form of unsupported solid particles.

K5. The improvement according to K1 wherein the hydroxyaluminoxane is introduced in the form of one or more solids on a carrier material.

K6. The improvement according to K5 wherein the one or more solids on the carrier material are in an inert viscous liquid.

K7. The improvement according to K1 wherein the hydroxyaluminoxane is introduced in the form of (i) a solution formed from the hydroxyaluminoxane in an inert solvent or in a liquid form of said at least one olefin, or both; (ii) a slurry formed from the hydroxyaluminoxane in an inert diluent or in a liquid form of said at least one olefin; (iii) unsupported solid particles; or (iv) one or more solids on a carrier material; or (v) any combination of two or more of (i), (ii), (iii), and (iv).

K8. The improvement according to any of K1, K2, K3, K4, K5, K6, or K7 wherein the d- or f-block metal compound is introduced in the form of undiluted solids or liquid.

K9. The improvement according to any of K1, K2, K3, K4, K5, K6, or K7 wherein the d- or f-block metal compound is introduced in the form of a solution or slurry of the d- or f-block metal compound in an inert solvent or diluent, or in a liquid form of said at least one olefin, or in a mixture of any of these.

Third Aspect

A1. A gelatinous composition of matter formed by bringing together at least (i) a hydroxyaluminoxane in an inert solvent and (ii) a treating agent, such that the gelatinous composition has a reduced OH-decay rate as compared to the OH-decay rate of the hydroxyaluminoxane.

A2. A composition according to A1 wherein the treating agent is comprised of water.

A3. A composition according to A2 wherein the composition is substantially insoluble in an inert organic solvent.

A4. A composition according to A3 wherein the hydroxyaluminoxane has less than 25 OH groups per 100 aluminum atoms.

A5. A composition according to A4 wherein the hydroxyaluminoxane has no more than 15 OH groups per 100 aluminum atoms.

A6. A composition according to A3 wherein the hydroxyaluminoxane consists essentially of hydroxyisobutylaluminoxane.

A7. A composition according to any of A1, A2, A3, A4, A5, or A6 wherein the OH-decay rate of said composition is reduced relative to the OH-decay rate of said hydroxyaluminoxane by a factor of at least 5.

A8. A solid composition of matter formed by removing at least some of said inert solvent from the gelatinous composition of matter which is in accordance with any of A1, A2, A3, A4, A5, or A6, said solid composition of matter being characterized by having a reduced OH-decay rate as compared to the OH-decay rate of the hydroxyaluminoxane.

B1. A gelantinous composition comprised of hydroxyaluminoxane and characterized by having an OH-decay rate which is reduced as compared to the OH-decay rate of the hydroxyaluminoxane in a liquid form.

B2. A composition according to B1 wherein said hydroxyaluminoxane has less than 25 hydroxyl groups per 100 aluminum atoms.

B3. A composition according to B1 wherein said hydroxyaluminoxane has less than 15 hydroxyl groups per 100 aluminum atoms.

B4. A composition according to B1 wherein said hydroxyaluminoxane consists essentially of hydroxyisobutylaluminoxane.

B5. A composition according to B1 wherein the OH-decay rate of said composition is reduced, as compared to that of said hydroxyaluminoxane in unsupported form, by a factor of at least 5.

B6. A composition according to B5 wherein said hydroxyaluminoxane has less than 25 hydroxyl groups per 100 aluminum atoms.

B7. A composition according to B5 wherein said hydroxyaluminoxane has less than 15 hydroxyl groups per 100 aluminum atoms.

B8. A composition according to B5 wherein said hydroxyaluminoxane consists essentially of hydroxyisobutylaluminoxane.

C1. A process comprising converting a hydroxyaluminoxane into a gelatinous composition of matter by bringing together (i) said hydroxyaluminoxane in an inert solvent and (ii) a treating agent compatible with said hydroxyaluminoxane, whereby the rate of OH-decay for said composition of matter is reduced relative to the rate of OH-decay of (i).

C2. A process according to C1 wherein said treating agent is comprised of water.

C3. A process according to C1 wherein said hydroxyaluminoxane of (i) has less than 25 OH groups per 100 aluminum atoms.

C4. A process according to C1 wherein said hydroxyaluminoxane of (i) has less than 15 OH groups per 100 aluminum atoms.

C5. A process according to C1 wherein said hydroxyaluminoxane of (i) consists essentially of hydroxyisobutylaluminoxane.

C6. A process according to C1 wherein said composition of matter is substantially insoluble in an inert organic solvent.

C7. A process according to C1 wherein the OH-decay rate of said composition is reduced, as compared to the OH-decay rate of (i), by a factor of at least 5.

C8. A process according to C7 wherein said treating agent is comprised of water.

C9. A process according to C7 wherein said hydroxyaluminoxane of (i) has less than 25 OH groups per 100 aluminum atoms.

C10. A process according to C7 wherein said hydroxyaluminoxane of (i) has less than 15 OH groups per 100 aluminum atoms.

C11. A process according to C7 wherein said hydroxyaluminoxane of (i) consists essentially of hydroxyisobutylaluminoxane.

C12. A process according to C7 wherein said composition of matter is substantially insoluble in an inert organic solvent.

D1. An activated catalyst composition formed by bringing together (A) a gelantinous composition of matter, or a solid composition of matter formed therefrom, or both, the gelatinous composition of matter being formed by bringing together at least (i) a hydroxyaluminoxane in an inert solvent and (ii) a treating agent compatible with said hydroxyaluminoxane, said gelantinous composition of (A) having a reduced OH-decay rate relative to the OH-decay rate of (i); and (B) a d- or f-block metal compound having at least one leaving group on a metal atom thereof.

D2. A catalyst composition according to claim D1 wherein said d- or f-block metal compound is a Group 4 metal.

D3. A catalyst composition according to claim D1 wherein said d- or f-block metal compound is a metallocene.

D4. A catalyst composition according to claim D3 wherein the d- or f-block metal of said metallocene is at least one Group 4 metal.

D5. A catalyst composition according to claim D3 wherein said metallocene contains two bridged or unbridged cyclopentadienyl-moiety-containing groups.

D6. A catalyst composition according to claim D5 wherein the Group 4 metal of said metallocene is zirconium.

D7. A catalyst composition according to claim D5 wherein the Group 4 metal of said metallocene is titanium.

D8. A catalyst composition according to claim D5 wherein the Group 4 metal of said metallocene is hafnium.

D9. A catalyst composition according to any of D1, D2, D3, D4, D5, D6, D7, or D8 wherein said hydroxyaluminoxane of (i) has less than 25 hydroxyl groups per 100 aluminum atoms.

D10. A catalyst composition according to any of D1, D2, D3, D4, D5, D6, D7, or D8 wherein said hydroxyaluminoxane of (i) consists essentially of hydroxyisobutylaluminoxane.

D11. A catalyst composition according to any of D1, D2, D3, D4, D5, D6, D7, or D8 wherein said composition in a dry or substantially dry state is able to be maintained at a temperature in the range of 10 to 60° C. for a period of at least 48 hours without losing fifty percent (50%) or more of its catalytic activity.

E1. A process of preparing an activated olefin polymerization catalyst composition, which process comprises bringing together (A) a gelantinous composition of matter, or a solid composition of matter formed therefrom, or both, the gelatinous composition of matter being formed by bringing together (i) a hydroxyaluminoxane in an inert solvent and (ii) a treating agent compatible with said hydroxyaluminoxane, whereby the rate of OH-decay for said composition is reduced relative to the rate of OH-decay of (i); and (B) a d- or f-block metal compound having at least one leaving group on a metal atom thereof.

E2. A process according to E1 wherein (A) and (B) are brought together in an inert diluent.

E3. A process according to E1 wherein (A) and (B) are brought together in the absence of an inert diluent.

E4. A process according to E1 wherein said hydroxyaluminoxane of (i) consists essentially of hydroxyisobutylaluminoxane.

E5. A process according to E1 wherein said hydroxyaluminoxane of (i) has less than 25 hydroxyl groups per 100 aluminum atoms.

E6. A process according to E1 wherein said hydroxyaluminoxane of (i) has less than 15 hydroxyl groups per 100 aluminum atoms.

E7. A process according to E1 wherein said d- or f-block metal compound is a metallocene.

E8. A process according to E7 wherein said at least one leaving group of said metallocene is a methyl group.

E9. A process according to E7 wherein said metallocene contains two bridged or unbridged cyclopentadienyl-moiety-containing groups.

E10. A process according to E9 wherein the metal of said metallocene is a Group 4 metal.

E11. A process according to E10 wherein said Group 4 metal is zirconium.

E12. A process according to E10 wherein said Group 4 metal is titanium.

E13. A process according to E10 wherein said Group 4 metal is hafnium.

E14. A process according to any of E1, E2, E3, E4, E5, E6, E7, E8, E9, E10, E11, E12, or E13 wherein said activated catalyst composition is recovered and maintained at a temperature in the range of 10 to 60° C. for a period of at least 48 hours without losing fifty percent (50%) or more of its catalytic activity.

F1. An olefin polymerization process which comprises bringing together in a polymerization reactor or reaction zone (1) at least one polymerizable olefin and (2) an activated catalyst composition which is in accordance with any of D1, D2, D3, D4, D5, D6, D7, D8, D9, or D10.

F2. An olefin polymerization process according to F1 wherein the polymerization process is conducted as a gas-phase polymerization process.

F3. An olefin polymerization process according to F1 wherein the polymerization process is conducted in a liquid phase diluent.

F4. An olefin polymerization process according to F1 wherein the polymerization process is conducted as a fluidized bed process.

F5. An olefin polymerization process according to F1 wherein said hydroxyaluminoxane of (i) has less than 25 hydroxyl groups per 100 aluminum atoms.

F6. An olefin polymerization process according to F5 wherein the polymerization process is conducted as a gas-phase polymerization process.

F7. An olefin polymerization process according to F5 wherein the polymerization process is conducted in a liquid phase diluent.

F8. An olefin polymerization process according to F5 wherein the polymerization process is conducted as a fluidized bed process.

F9. An olefin polymerization process according to F1 wherein said hydroxyaluminoxane of (i) consists essentially of hydroxyisobutylaluminoxane.

G1. A process which comprises bringing together (i) an aluminum alkyl in an inert solvent and (ii) a water source, under hydroxyaluminoxane-forming reaction conditions and using an amount of (ii) sufficient to cause a gelatinous composition of matter to form.

G2. A process according to G1 wherein said aluminum alkyl is a trialkylaluminum.

G3. A process according to G1 wherein said water source consists essentially of free water.

G4. A process according to G1 wherein said aluminum alkyl is triisobutylaluminum, said water source is free water, and said amount of (ii) provides at least 1.1 molar equivalents of oxygen in (ii) to aluminum in (i).

G5. A process according to G1 further comprising bringing together said gelatinous composition of matter and a d- or f-block metal compound having at least one leaving group on a metal atom thereof, so as to form an activated polymerization catalyst.

G6. A process according to G5 wherein said d- or f-block metal compound is a metallocene.

G7. A process according to G6 wherein said at least one leaving group of said metallocene is a methyl group.

G8. A process according to G6 wherein said metallocene contains two bridged or unbridged cyclopentadienyl-moiety-containing groups.

G9. A process according to G8 wherein the metal of said metallocene is a Group 4 metal.

G10. A process according to G9 wherein said Group 4 metal is zirconium.

G11. A process according to G9 wherein said Group 4 metal is titanium.

G12. A process according to G9 wherein said Group 4 metal is hafnium.

G13. A process according to G1 further comprising removing solvent from said gelatinous composition of matter so as to form a solid composition of matter, and then bringing together said solid composition of matter and a d- or f-block metal compound having at least one leaving group on a metal atom thereof, so as to form an activated polymerization catalyst.

G14. A process according to G13 wherein said d- or f-block metal compound is a metallocene.

G15. A process according to G14 wherein said at least one leaving group of said metallocene is a methyl group.

G16. A process according to G14 wherein said metallocene contains two bridged or unbridged cyclopentadienyl-moiety-containing groups.

G17. A process according to G16 wherein the metal of said metallocene is a Group 4 metal.

G18. A process according to G17 wherein said Group 4 metal is zirconium.

G19. A process according to G17 wherein said Group 4 metal is titanium.

G20. A process according to G17 wherein said Group 4 metal is hafnium.

The materials referred to by chemical name or formula anywhere in the specification or claims hereof are identified as ingredients to be brought together in connection with performing a desired operation or in forming a mixture to be used in conducting a desired operation. Accordingly, even though the claims hereinafter may refer to substances in the present tense (“comprises”, “is” and so forth), the reference is to the substance, as it existed at the time just before it was first contacted, blended or mixed with one or more other substances in accordance with the present disclosure. The fact that a substance may lose its original identity through a chemical reaction, complex formation, solvation, ionization, or other transformation during the course of contacting, blending or mixing operations, if done in accordance with the disclosure hereof and with the use of ordinary skill of a chemist and common sense, is within the purview and scope of this invention.

That which is claimed is:

1. A process which comprises bringing together in an inert atmosphere and in an inert anhydrous solvent medium, the d-block or f-block metal compound and a hydroxyaluminoxane; recovering a resulting product compound; storing the recovered product compound in an anhydrous, inert atmosphere or environment; and maintaining said product compound in undissolved form except during one or more optional finishing procedures, if any such finishing procedure is performed.

2. A process of claim 1 wherein said hydroxyaluminoxane before being brought together with said d- or f-block metal compound has a ratio of less than one hydroxyl group per aluminum atom.

3. A process of claim 1 wherein the hydroxyaluminoxane before being brought together with said d- or f-block metal compound is an alkylaluminoxane in which at least one aluminum atom has a hydroxyl group bonded thereto, and in which the alkyl groups each contain at least two carbon atoms.

4. A process of claim 3 wherein the alkyl groups are isobutyl groups.

5. A process of claim 1 wherein the metal-containing product compound while being maintained in said undissolved form is in isolated form, or is in supported form on a catalyst support material.

6. A process which comprises bringing together (i) a hydroxyaluminoxane and (ii) a carrier material or a support material.

7. A process of claim 6 wherein (ii) is a particulate inorganic catalyst support material.

8. A process of claim 6 wherein (ii) is comprised of anhydrous or substantially anhydrous particles of silica, silica-alumina, or alumina.

9. A process of claim 6 wherein (ii) is a particulate porous calcined silica or a particulate porous silica pretreated with an aluminum alkyl.

10. An olefin polymerization process which comprises bringing together in a polymerization reactor or reaction zone at least (1) one or more polymerizable olefins and (2) an activated catalyst composition formed by bringing together at least (A) a gelatinous composition formed by bringing together at least (i) a hydroxyaluminoxane in an inert solvent and (ii) a treating agent that is able to form a gelatinous composition, or a solid composition formed by removing at least some of said inert solvent from said gelatinous composition, or both of said gelatinous composition and said solid composition, and (B) a d- or f-block metal compound having at least one leaving group on a metal atom thereof, to form a polymer.

11. A process of claim 10 wherein the treating agent of (ii) is comprised of water.

12. A process of claim 11 wherein the gelatinous composition is substantially insoluble in hexane.

13. A process of claim 11 wherein the hydroxyaluminoxane before inclusion in said inert solvent has less than 25 OH groups per 100 aluminum atoms.

14. A process of claim 13 wherein said hydroxyaluminoxane has no more than 15 OH groups per 100 aluminum atoms.

15. A process of claim 11 wherein the hydroxyaluminoxane before inclusion in said inert solvent is hydroxyisobutylaluminoxane.

16. A process of any of claims 10 through 15 characterized by having when freshly prepared a lower OH-decay rate than the OH-decay rate of said hydroxyaluminoxane by a factor of at least 5.

17. A process of claim 10 wherein the d- or f-block metal of said d- or f-block metal compound is a Group 4 metal.

18. A process of claim 10 wherein said d- or f-block metal compound is a metallocene.

19. A process of claim 18 wherein the d- or f-block metal of said metallocene is at least one Group 4 metal.

20. A process of claim 18 wherein said metallocene contains two bridged or unbridged cyclopentadienyl-moiety-containing groups.

21. A process of claim 20 wherein the Group 4 metal of said metallocene is zirconium or hafnium.

22. A process of any of claims 10, 11, 13, 15, or 17-21 wherein said activated catalyst composition in a dry or substantially dry state is able to be maintained at a temperature in the range of 10 to 60° C. for a period of at least 48 hours without losing fifty percent (50%) or more of its catalytic activity.

23. A process of any of claims 10, 11, 17, 18, 19, or 20 wherein the polymerization process is conducted as a gas-phase polymerization process.

24. A process of any of claims 10, 11, 17, 18, 19, or 20 wherein the polymerization process is conducted in a liquid phase diluent.

25. A process of any of claims 10, 11, 17, 18, 19, or 20 wherein the polymerization process is conducted as a fluidized bed process.
